(19) United States
(12) Patent Application Publication
(10) Pub. No.: US 2006/0178204 A1
(43) Pub. Date: Aug. 10, 2006

(54) Gaming machine and gaming system

(76) Inventor: Kazuo Okada, Tokyo (JP)

Correspondence Address: ARENT FOX PLLC, 1050 CONNECTICUT AVENUE, N.W., SUITE 400, WASHINGTON, DC, 20036, US

(21) Appl. No.: 11/296,695

(22) Filed: Dec. 8, 2005

(30) Foreign Application Priority Data
Dec. 10, 2004 (JP) 2004-358886
Dec. 10, 2004 (JP) 2004-358890

(51) Int. Cl. A63F 13/00

(52) U.S. Cl. 463/20; 463/37

(57) ABSTRACT

A gaming machine includes: a game processing unit that performs game processing to provide a game to a player; a display unit that displays a game image related to the game provided by the game processing unit; a movable holding unit that holds a reading object mounted thereon, the reading object being provided with a storage medium in which an identification information that identifies the reading object is stored; an information reading unit that reads the identification information from the reading object mounted on the movable holding unit; an actuating unit that actuates the movable holding unit; and a control unit that controls the actuating unit to move the reading object being mounted on the movable holding unit in response to the progress of the game provided by the game processing unit, when the identification information is read by the information reading unit.

### CROSS-REFERENCE TO THE RELATED APPLICATION(S)

The present application is based upon and claims priorities from two prior Japanese Patent Applications No. 2004-358886 and No. 2004-358890, both filed on Dec. 10, 2004, the entire contents of which are incorporated herein by reference.

### BACKGROUND

1. Field of the Invention

The present invention relates to a gaming machine and a gaming system which includes a display unit that displays a game image for use in a game or a variable display unit that variably displays a plurality of symbols, and which perform a game using the game image or the plurality of symbols.

2. Description of the Related Art

A gaming machine has heretofore existed configured as follows. That is, a plurality of symbols are variably displayed in a plurality of rows mechanically or graphically. And, whether a game is won or not and a state in which the game is won (winning state) are determined based on the combination of symbols stopped in each row. Game medium for use in the game such as medals or coins (henceforth called “coins”) are paid out in response to the winning state. The above-described type of gaming machine includes a gaming machine which starts a bonus game, under conditions that a specific symbol is displayed stopped, in addition to a base game in which normal payout is performed. Furthermore, the above-described type of gaming machine includes a gaming machine which notifies a player of the transition to the bonus game in a variety of manners, in addition to a specific symbol that is displayed stopped, for the benefit of the player who anticipates the transition to the bonus game.

For example, there is disclosed in JP-A-2004-049408 a gaming machine in which an effect image notifying the player of the transition from the base game to the bonus game is displayed to notify the player of the transition to the bonus game.

There is disclosed in JP-A-2003-024510 a gaming machine which pre-notifies the player of the transition to the bonus game, using the display or sound of a character image or the vibration of the cabinet of the gaming machine before the transition to the bonus game.

However, in the aforementioned gaming machines, the progress of the image game is controlled using a game image for use in the game, such as symbols variably displayed or symbol variable display images. Therefore, in order for the player to comprehend the game progress, there is no way other than paying attention to the game image such as the symbols, the effect images, or the character images. In addition, in the gaming machine disclosed in JP-A-2003-024510, although the pre-notification of the transition to the bonus game is performed using means other than the image display, such pre-notification is performed using a component set to the gaming machine, such as the cabinet. Therefore, in each aforementioned gaming machine, only the component set to the gaming machine is engaged in the notification of the progress, which lacks variety and creates limitations.

### SUMMARY

The present invention provides a gaming machine and a gaming system capable of increasing the entertainment of a game by diversifying the notification of the progress of a game.

A gaming machine includes: a game processing unit that performs game processing to provide a game to a player; a display unit that displays a game image related to the game provided by the game processing unit; a movable holding unit that holds a reading object mounted thereon, the reading object being provided with a storage medium in which an identification information that identifies the reading object is stored; an information reading unit that reads the identification information from the reading object mounted on the movable holding unit; an actuating unit that actuates the movable holding unit; and a control unit that controls the actuating unit to move the reading object being mounted on the movable holding unit in response to the progress of the game provided by the game processing unit, when the identification information is read by the information reading unit.

A gaming system includes: a gaming machine; and a server that is connected to the gaming machine through a computer network. The gaming machine includes: a game processing unit that performs game processing to provide a game to a player; a display unit that displays a game image related to the game provided by the game processing unit; a movable holding unit that holds a reading object mounted thereon, the reading object being provided with a storage medium in which an identification information that identifies the reading object is stored; an information reading unit that reads the identification information from the reading object mounted on the movable holding unit; an actuating unit that actuates the movable holding unit; a control unit that controls the actuating unit to move the reading object being mounted on the movable holding unit; and a first communication unit that transmits the identification information read by the information reading unit to the server. The server includes a second communication unit that transmits a history information that indicates a history of usage of the reading object that is identified by the identification information transmitted from the first communication unit of the gaming machine. The control unit controls the actuating unit to move the reading object being mounted on the movable holding unit in accordance with the history information transmitted from the second communication unit of the server.

A gaming machine includes: a game processing unit that performs game processing to provide a game to a player; a display unit that displays a game image related to the game provided by the game processing unit; a light emitting holding unit that holds a reading object mounted thereon and emits light to illuminate the reading object, the reading object being provided with a storage medium in which an identification information that identifies the reading object is stored; an information reading unit that reads the identification information from the reading object mounted on the movable holding unit; and a control unit that controls the light emission unit to illuminate the reading object in response to the progress of the game provided by the game processing unit, when the identification information is read by the information reading unit.

A gaming system includes: a gaming machine; and a server that is connected to the gaming machine through a computer network. The gaming machine includes: a game processing unit that performs game processing to provide a game to a player; a display unit that displays a game image related to the game provided by the game processing unit; a light emitting holding unit that holds a reading object mounted thereon and emits light to illuminate the reading object, the reading object being provided with a storage medium in which an identification information that identifies the reading object is stored; an information reading unit that reads the identification information from the reading object mounted on the movable holding unit; a control unit that controls the light emission unit to illuminate the reading object in response to the progress of the game provided by the game processing unit; and a first communication unit that transmits the identification information read by the information reading unit to the server. The server includes a second communication unit that transmits a history information that indicates a history of usage of the reading object that is identified by the identification information transmitted from the first communication unit of the gaming machine. The control unit controls the light emission unit to illuminate the reading object in accordance with the history information transmitted from the second communication unit of the server.

### BRIEF DESCRIPTION OF THE DRAWINGS

In the accompanying drawings:

FIG. 1 is a perspective view showing the overall configuration of a slot machine according to a first embodiment;

FIG. 2 is a schematic view showing the outlined configuration of a toy figure mounting unit having a toy figure set thereon;

FIG. 3 is a plan diagram showing the external configuration of a control panel;

FIG. 4 is a block diagram of the slot machine showing the main internal configuration thereof;

FIG. 5 is a block diagram showing an example of the internal configuration of an image control circuit;

FIG. 6 is a flowchart showing the operation from the start to the end of a slot game;

FIG. 7 is a flowchart showing the operation of a toy figure information read process;

FIG. 8 is a flowchart showing the operation of a lottery process;

FIG. 9 is a flowchart showing the operation of a base game process;

FIG. 10 is a flowchart showing the operation of a bonus game notification process;

FIG. 11 is a view showing an example of an image displayed on a main display;

FIG. 12 is a table showing an example of a history management file;

FIG. 13 is a table showing an example of a notification pattern table;

FIG. 14 is a schematic view showing the toy figure in motion;

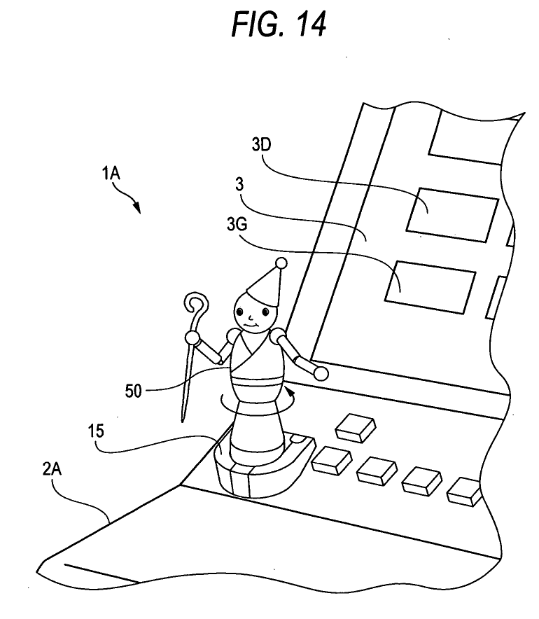

FIG. 15 is a schematic view showing the outlined configuration of a toy figure mounting unit of a slot machine according to a second embodiment;

FIG. 16 is a perspective view showing the overall configuration of a slot machine according to a third embodiment;

FIG. 17 is a block diagram showing the outlined configuration of a gaming system according to a fourth embodiment;

FIG. 18 is a flowchart showing the operation from the start to the end of a slot game on the gaming system;

FIG. 19 is a perspective view showing the overall configuration of a slot machine according to a fifth embodiment;

FIG. 20 is an exploded perspective view of a toy figure mounting unit;

FIG. 21 is a plan diagram showing the external configuration of a control panel;

FIG. 22 is a block diagram of the slot machine showing the main internal configuration thereof;

FIG. 23 is a block diagram showing an example of the internal configuration of an image control circuit;

FIG. 24 is a front, partly-broken, elevational view of a toy figure;

FIG. 25 is a schematic perspective view showing the toy figure having been mounted on the toy figure mounting unit;

FIG. 26 is a flowchart showing the operation from the start to the end of a slot game;

FIG. 27 is a flowchart showing the operation of a toy figure information read process;

FIG. 28 is a flowchart showing the operation of a lottery process;

FIG. 29 is a flowchart showing the operation of a base game process;

FIG. 30 is a flowchart showing the operation of a bonus game notification process;

FIG. 31 is a table showing an example of a history management file;

FIG. 32 is a table showing an example of a notification pattern table;

FIG. 33 is a view showing an example of an image displayed on a main display;

FIG. 34 is a perspective view showing the overall configuration of a slot machine according to a sixth embodiment;

FIG. 35 is a block diagram showing the outlined configuration of a gaming system according to a seventh embodiment; and

FIG. 36 is a flowchart showing the operation from the start to the end of a slot game on the gaming system.

### DETAILED DESCRIPTION OF THE EMBODIMENTS

Embodiments of the invention will hereafter be described. In the accompanying drawings and in the description thereof, the same reference numerals are used to identify the same components, thus avoiding redundant description.

### First Embodiment

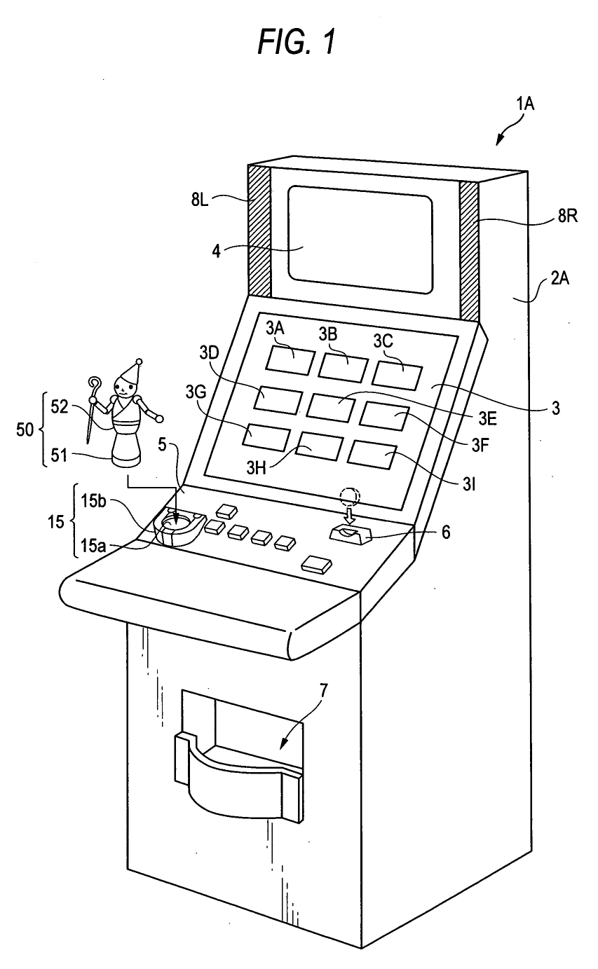

FIG. 1 is a perspective view showing an overall configuration of a slot machine 1A. The slot machine 1A is a gaming machine according to a first embodiment. The slot machine 1A, having a plurality of variable display windows for displaying a plurality of symbol variable display images, is configured to be capable of performing a variable display game (also called a slot game) which uses the variable display images displayed in the respective variable display windows. The variable display game is performed in one of a base game state in which started without conditions from the start of the variable display game, and in a bonus game state in which started under predetermined conditions subsequent to the base game. The slot machine 1A provides the game in either one of a normal gaming mode in which the base game is performed and a special gaming mode in which the bonus game is performed, and is thus configured to be capable of performing the variable display game in the special gaming mode as well as in the normal gaming mode.

The slot machine 1A includes a toy figure mounting unit 15 on which a player can mount a three-dimensional toy FIG. 50 (which will be described later). The toy FIG. 50 is moved as a movable pedestal 15a of the toy figure mounting unit 15 moves in response to a game progress, such as during the base game or before execution of the bonus game, thus notifying a player of the game progress. The configuration of the slot machine 1 will be described in detail below.

The slot machine 1A includes, on the front side of a cabinet 2A, a main display 3 that is provided with a liquid crystal display device. The slot machine 1A includes, in a portion thereof above the main display 3, a subsidiary display 4 that is provided with a liquid crystal display device. Speakers 8L and 8R for producing a sound to be used in a game effect are located on both left and right sides of the subsidiary display 4.

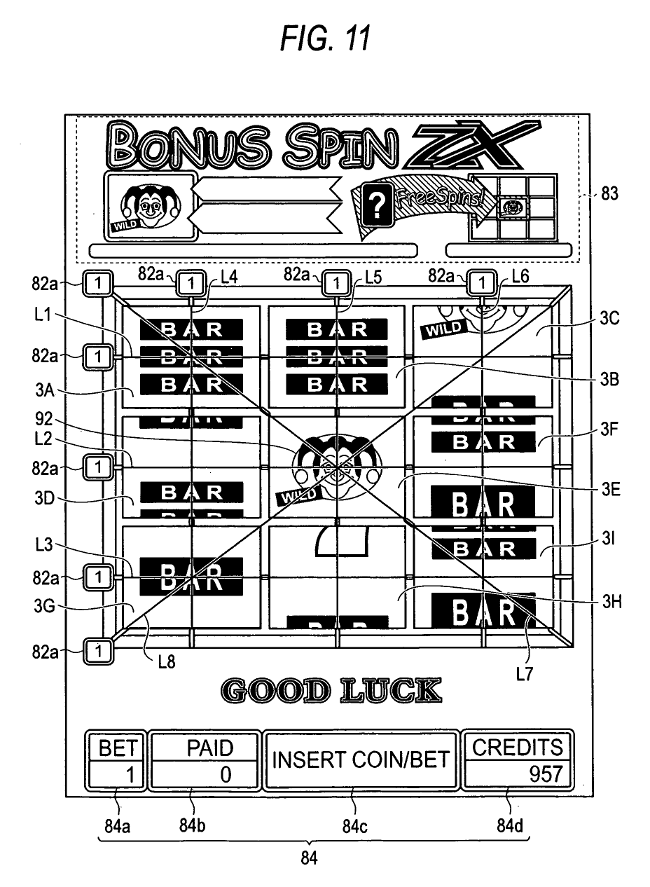

The main display 3 that serves as a display unit, has a total of nine variable display windows 3A, 3B, 3C, 3D, 3E, 3F, 3G, 3H, and 3I arranged in a three-by-three matrix. The main display 3 is configured such that scrolling display images (reel images displayed to resemble mechanical reels rotating) resembling a plurality of symbols moving downward are displayed in the variable display windows 3A to 3I both in the normal gaming mode and in the special gaming mode. As shown in FIG. 11, the slot machine 1A has the nine variable display windows 3A to 3I, and is therefore configured such that a total of eight activated lines (L1 to L8), arranged in a three-by-three matrix and diagonally, are set up on the nine variable display windows 3A to 3I.

Images not directly engaged in the game (e.g., description of a game content) are displayed on the subsidiary display 4.

The slot machine 1A includes, below the main display 3, the toy figure mounting unit 15 on which the toy FIG. 50 is to be mounted, a control panel 5, and a coin insertion slot 6 in which to insert coins to be bet in the game. A drive device 60A for moving the movable pedestal 15a of the toy figure mounting unit 15 is provided inside the cabinet 2A, and a coin receiving tray 7 for collecting coins paid out is provided in a lower portion of the cabinet 2A.

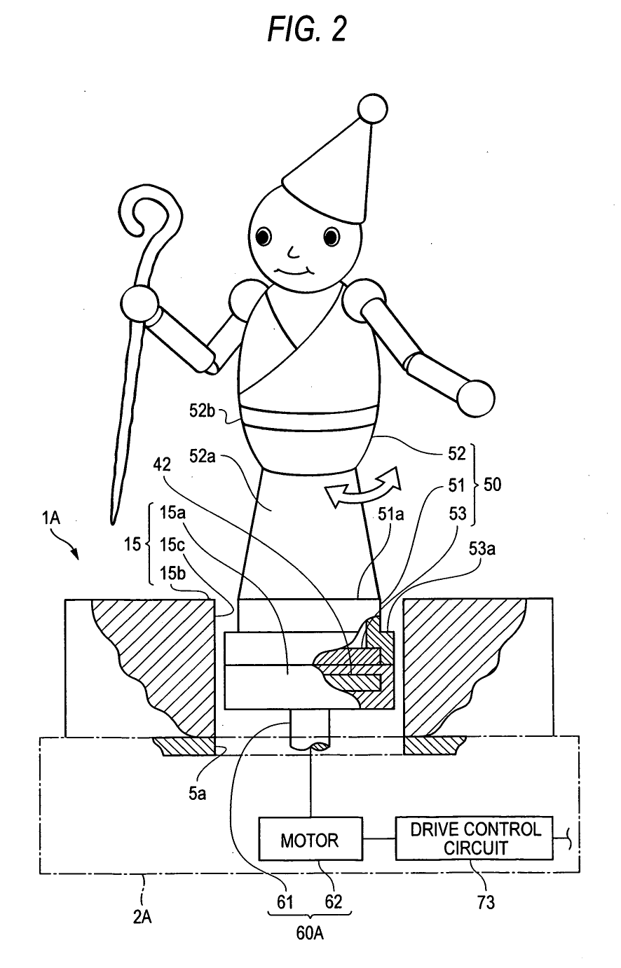

The toy figure mounting unit 15 includes the movable pedestal 15a which can rotate with the toy FIG. 50 supported thereon and a frame 15b which, provided surrounding the movable pedestal 15a, is used to keep the toy FIG. 50 supported. The toy figure mounting unit 15 is thus configured to hold the toy FIG. 50 so that to-be-described toy figure ID can be read by an IC chip reader/writer 42 (see FIG. 2), and to be able to move while holding the toy FIG. 50. The toy figure mounting unit 15 has the IC chip reader/writer 42 embedded in the movable pedestal 15a. The toy figure mounting unit 15 serves as a movable holding unit of the invention, and the IC chip reader/writer 42 serves as a read out unit.

Specifically, as shown in FIGS. 1 and 2, the movable pedestal 15a, formed into a thick disk shape, has one end face (upper surface) having a size capable of supporting a seat 51 of the toy figure and the other end face (lower surface) to be set to a to-be-described rotary shaft 61 projecting through a through hole 2a from the inside of the cabinet 2A. The movable pedestal 15a is rotatably supported from below by the rotary shaft 61. The frame 15b has a generally annular or hollow and cylindrical projecting configuration having a height capable of supporting the seat 51 of the toy FIG. 50 on the to-be-described control panel 5. The frame 15b, having formed therein a cylindrical hole 15c inside which the movable pedestal 15a is to be installed, is set so that the cylindrical hole 15c is aligned with the through hole 5a of the control panel 5. The IC chip reader/writer 42, including an antenna, a wireless circuit, and the like, is embedded in the movable pedestal 15 so that the to-be-described toy figure ID can be read when the toy FIG. 50 is mounted on the toy figure mounting unit 15. The IC chip reader/writer 42 is also configured to be capable of writing predetermined information to an IC chip 53 of the toy FIG. 50 in accordance with an instruction from a main CPU 32 when the toy FIG. 50 is mounted on the toy figure mounting unit 15.

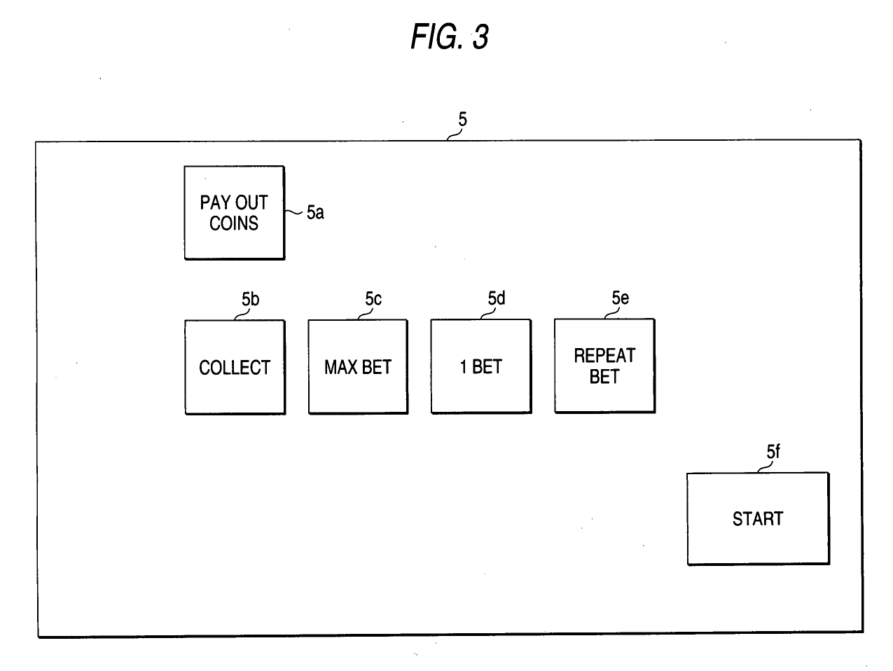

As shown in FIG. 3, the control panel 5 has a PAYOUT button 5a for instructing the payout of coins, a COLLECT button 5b for collecting coins won in the game, a MAX-BET button 5c for placing the bet of a maximum number of coins, a 1-BET button 5d for placing the bet of one coin, a REPEAT-BET button 5e for betting the same number of coins as in the previous game and giving an instruction to start the game, and a START button 5f for giving an instruction to start the game.

As shown in FIG. 2, the drive device 60A has a motor 62 for generating power to move (rotate) the movable pedestal 15a and the rotary shaft 61 (power transmission mechanism) one end of which is coupled to the drive shaft of the motor 62 via a reduction gear and the like, and the other end of which is set to-the movable pedestal 15a. In the embodiment, the drive device 60A serves as a actuating unit of the invention, the motor 62 corresponds to the power generator, the rotary shaft 61 serves as a power transmission mechanism. The motor 62 is electrically connected to a to-be-described drive control circuit 73 and is thus controlled as to its operation by the drive control circuit 73.

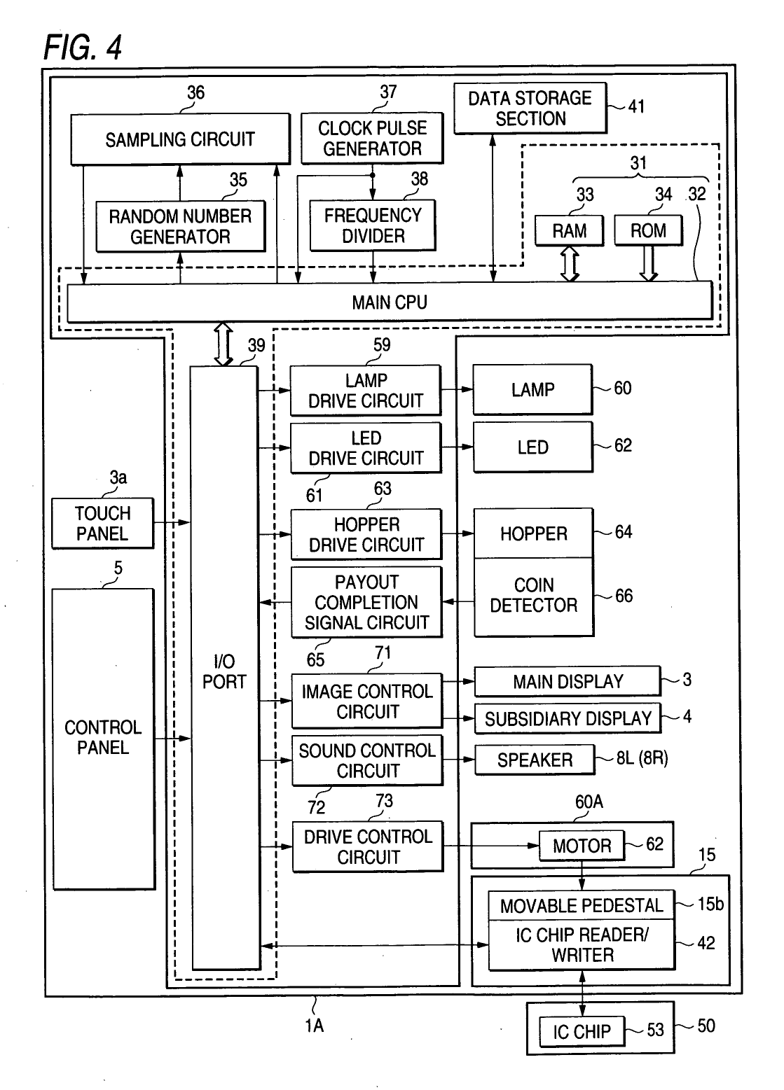

FIG. 4 is a block diagram showing a main internal configuration of the slot machine 1A. The slot machine 1A has a plurality of components including a microcomputer 31 as a core component.

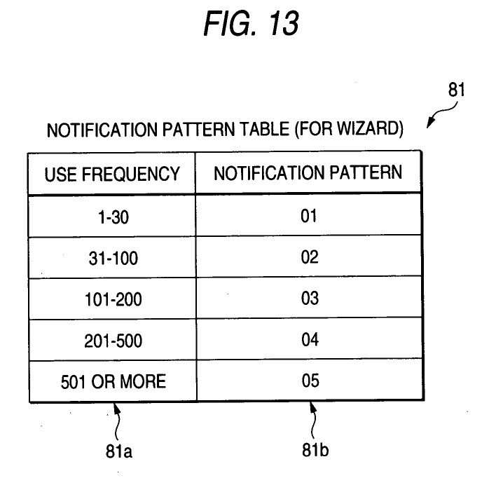

The microcomputer 31 includes a main CPU (Central Processing Unit) 32, a RAM (Random Access Memory) 33, and a ROM (Read Only Memory) 34. The main CPU 33 operates in accordance with a program stored in the ROM 34 to receive signals from the sections of the control panel 5 via an I/O port 39 and at the same time to exchange signals with the other components, thus controlling the operation of the entire slot machine 1A. The RAM 33 stores data and a program which are used upon operation of the main CPU 32, for example, after the start of the game, the RAM 33 temporarily holds random number values sampled by a to-be-described sampling circuit 36. The ROM 34 stores a program to be executed by the main CPU 32 and permanent data, e.g., a to-be-described notification pattern table 81 (see FIG. 13).

The slot machine 1A includes a random number generator 35, the sampling circuit 36, a clock pulse generator 37, a frequency divider 38, and a data storage unit 41. The random number generator 35 operates in accordance with an instruction from the main CPU 32 to generate a set range of random numbers. The sampling circuit 36 extracts any random number from the random numbers generated by the random number generator 35 and inputs the extracted random number to the main CPU 32. The clock pulse generator 37 generates a reference clock for operating the main CPU 32, and the frequency divider 38 sends, to the main CPU 32, signals obtained by dividing the reference clock by a set frequency. The data storage unit 41 stores a to-be-described history management file 80 (FIG. 13) in response to the toy figure ID of the toy FIG. 50. The history management file 80 has a record consisting of a toy figure ID field 80a, a toy figure type field 80b, and a use frequency field 80c, wherein a toy figure type and a use frequency are related to the toy figure ID. The toy figure type refers to a kind typified in response to the alphanumeric characters of the toy figure ID, for example, “wizard” or “warrior”. The use frequency corresponds to the number of times that the slot game is played with the toy FIG. 50 mounted on the toy figure mounting unit 15, wherein the number of times that the toy figure ID has been read in a to-be-described toy figure information read process is counted and stored.

In the first embodiment, data stored in the record of the history management file 80 corresponds to the history information, and the record is created and updated by the main CPU 32.

The slot machine 1A includes a touch panel 3a, a lamp drive circuit 59, a lamp 60, an LED drive circuit 61, LED's 62, a hopper drive circuit 63, a hopper 64, a payout completion signal circuit 65, and a coin detector 66. The slot machine 1A includes an image control circuit 71, a sound control circuit 72, the drive control circuit 73, and the IC chip reader/writer 42.

The touch panel 3a that is provided to cover the display screen of the main display 3, detects the position of a portion of which the player has touched with a finger and transmits to the main CPU 32 a position signal corresponding to the detected position. The lamp drive circuit 59 sends to the lamp 60 a signal for lighting the lamp 60, thus flashing the lamp 60 during the execution of the game. An effect of the game is performed with this flash. The LED drive circuit 61 controls the flash display of the LED's 62. The LED's 62 display the number of credits, the number of coins won, and the like. The hopper drive circuit 63 drives the hopper 64 in accordance with the control of the main CPU 32, and the hopper 64, which operates to pay out won coins, pays out the coins to the coin receiving tray 7 from a payout opening. The coin detector 66 counts the number of coins paid out by the hopper 64 and notifies the payout completion signal circuit 65 of data consisting of the number of coins counted. The payout completion signal circuit 65 receives the data consisting of the number of coins from the coin detector 66 and sends a signal indicative of the notification of coin payout completion to the main CPU 32 when the data has reached a set number of coins.

The image control circuit 71 controls the image display of each of the main display 3 and the subsidiary display 4 to display a variety of images, such as the plurality of symbol variable display images, on the main display 3 and the subsidiary display 4.

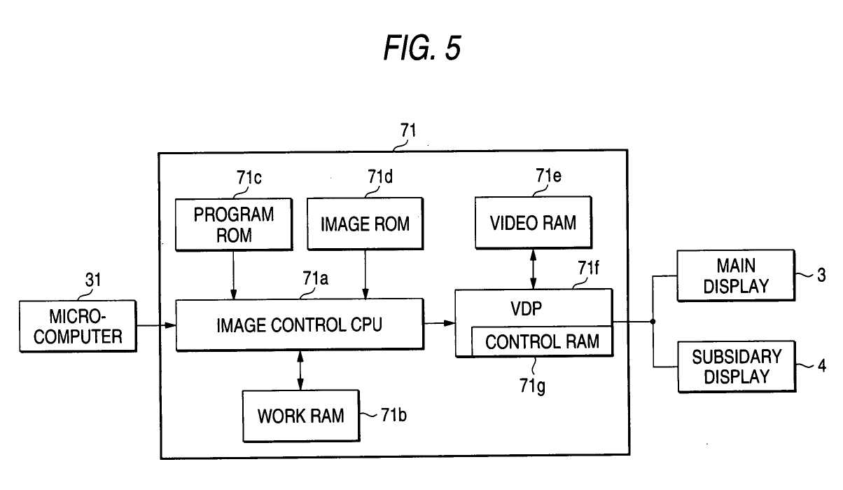

As shown in FIG. 5, the image control circuit 71 has an image control CPU 71a, a work RAM 71b, a program ROM 71c, an image ROM 71d, a video RAM 71, and a VDP (Video Display Processor) 71f. Based on parameters set by the microcomputer 31, the image control CPU 71a determines images (such as reel images and stopped symbol images to be displayed when the scrolling display is stopped) to be displayed on the main display 3 and the subsidiary display 4, in accordance with image control programs (related to the display on the main display 3 and the subsidiary display 4) preset in the program ROM 71c. The work RAM 71b is configured as temporary storage unit to be used when the image control CPU 71a executes the image control programs.

The program ROM 71c stores the image control programs, various selection tables, and the like. The image ROM 71d stores bitmap data (dot data) for forming images. In the embodiment, this dot data includes symbol image data consisting of symbols to be used in the base game and the bonus game. The video RAM 71e is configured as temporary storage unit to be used when the VDP 71f forms images. The VDP 71f, having a control RAM 71g, forms images corresponding to the display contents of the main display 3 and the subsidiary display 4, which have been determined by the image control CPU 71a, and outputs the formed images on the main display 3 and the subsidiary display 4.

The sound control circuit 72 sends to the speakers 8L and 8R a sound signal to produce a sound from the speakers 8L and 8R. From the speakers 8L and 8R is produced, for example, a sound to add excitement to the game at an appropriate time, such as before the start of the game or during the game.

The drive control circuit 73 sends a drive signal to the motor 62 in accordance with an instruction from the main CPU 32. The motor 62 operates based on the drive signal sent from the drive control circuit 73 to rotate the rotary shaft 61 (see FIG. 2) via the reduction gear and the like. The rotary shaft 61 transmits the power (torque), produced by the motor 62, to the movable pedestal 15a, thus rotating the movable pedestal 15a.

The IC chip reader/writer 42 is embedded in the movable pedestal 15a (see FIG. 2), and when the toy FIG. 50 is mounted on the movable pedestal 15a, the IC reader/writer reads and transmits the toy figure ID to the main CPU 32.

As shown in FIG. 2, the toy FIG. 50 is provided with a seat 51, a toy figure body 52, and the IC chip 53 for storing the toy figure ID.

The seat 51, having a size corresponding to the cylindrical hole 15c of the toy figure mounting unit 15, is formed into a flat-bottomed cylindrical shape having a top portion 51a, and has a configuration such that the IC chip 53 is fixedly fitted in an open end portion.

The toy figure body 52 is configured to have a leg portion 52a set to the top portion 51a of the seat 51 and a figurine portion 52b which, formed upright on the leg portion 52a, represents a wizard, a warrior, and the like.

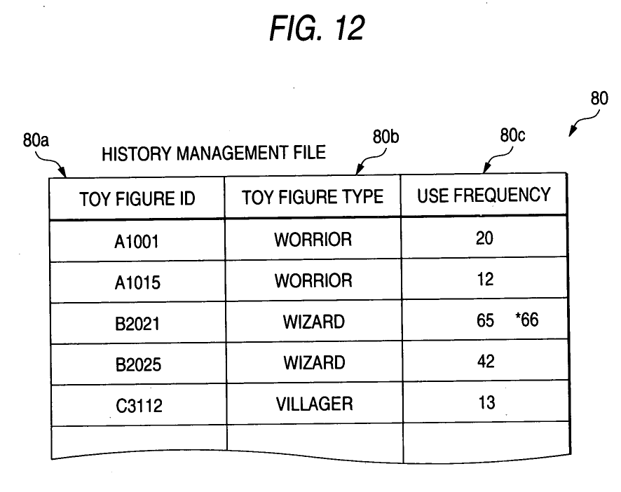

The IC chip 53 stores a toy figure ID that is inherent to each toy FIG. 50. The toy figure ID consists of an Alphabet letter and 4-digit number. The Alphabet letter indicates the type of a toy figure corresponding to the shape of the toy figure body 52 (e.g., “A” indicates the wizard, “B” indicates the warrior, “C” indicates a villager, and so on). The 4-digit number indicates a unique identification number for distinguishing one toy figure from another (differentiating a player's toy figure from others). The toy FIG. 50 is thus configured such that the player can identify the type of a character by the shape of the toy figure body 52, and such that the slot machine 1A can identify each toy figure and the toy figure type by which it is classified. The toy FIG. 50 of the embodiment is the “wizard”, and the toy figure ID thereof is “B2021” (see FIG. 12). The toy FIG. 50 corresponds to the reading object, and the toy figure ID corresponds to the identification information of the invention.

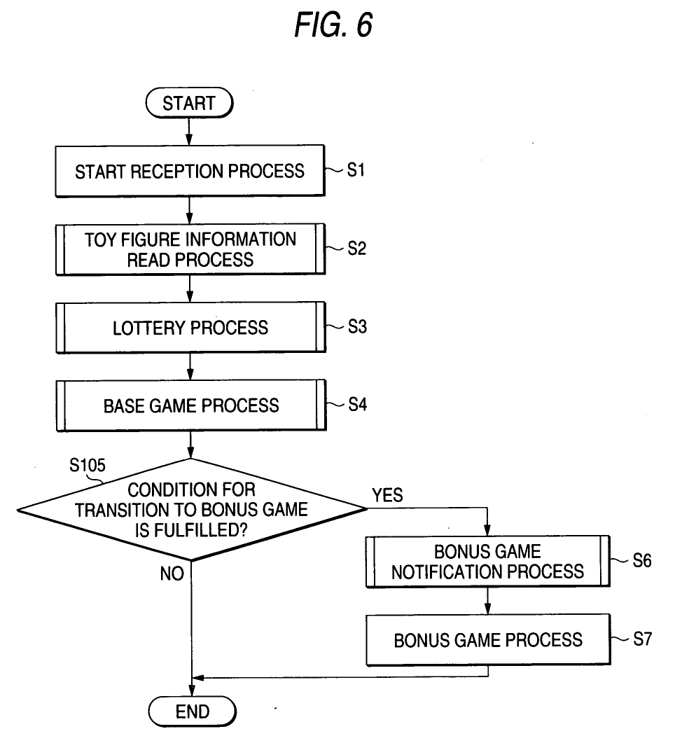

The operation of the slot machine 1A having the aforementioned configuration will now be described with reference to flowcharts shown in FIGS. 6 to 10. In the slot machine 1A, as shown in FIG. 6, first, the base game is executed, and subsequently the bonus game is executed under set conditions. Before the execution of the bonus game, the movement of the toy FIG. 50 notifies the player of a transition to the bonus game.

FIGS. 6 to 10 are flowcharts showing the operation of a main process from the start to the end of the game on the slot machine 1A, a toy figure information read process, a lottery process, a base game process, and a bonus game notification process, respectively. In FIGS. 6 to 10, the term step is abbreviated as “S”.

In the slot machine 1A, the main CPU 32, operating as the game progress control unit, controls the progress of the game. In the slot machine 1A, as shown in FIG. 6, when the main process is started, a start reception process is performed in step 1 to start the game, the toy figure information read process is performed in the subsequent step 2, and the lottery process is then performed in the subsequent step 3. In the subsequent step 4, the base game process is performed with the gaming mode in the normal gaming mode, and the process then proceeds to step 5. In step 5, in response to the result of the lottery process in step 3, the main CPU 32 determines whether the condition for making a transition to the bonus game (transition condition) is fulfilled or not. If the transition condition is not fulfilled here, the main process is terminated. However, if the transition condition is fulfilled, the main CPU 32 allows the gaming mode to make a transition from the normal gaming mode to the special gaming mode. After the process proceeds to step 6 to perform the bonus game notification process, a bonus game process (step 7) is performed, and the main process then ends. The details of each block will be described below.

First, when the process proceeds to the start reception process of step 1, the slot machine 1A receives input to start the game from the player, in accordance with the control of the main CPU 32. Since the slot machine 1A is a coin insertion type gaming machine, in order for the player to start the game, first, the player either inserts a number of coins to be bet on one game using the coin insertion slot 6, or, if any credits are remaining, operates any of the MAX-BET button 5c, the 1-BET button 5d, and the REPEAT-BET button 5e. Subsequently, the player operates the START button 5f or the REPEAT-BET button 5e (henceforth called a “start operation”). By this operation, a start signal is sent from the START button 5f to the main CPU 32.

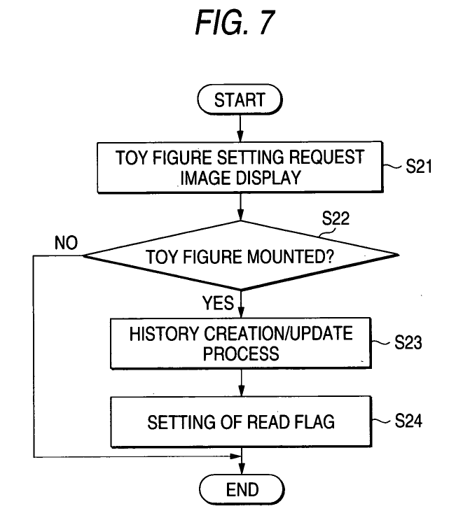

Next, the process proceeds to step 2 to perform a toy figure information read process. When the toy figure information read process starts, the process proceeds to step 21 shown in FIG. 7, wherein the main CPU 32 instructs the image control circuit 71 to display the following image (henceforth called a “request image”) on the main display 3: the image requiring a player possessing a toy figure to mount the toy figure, or the image requiring a player possessing no toy figure to select “no toy figure”. In accordance with this request image, the player possessing the toy FIG. 50 can mount the toy FIG. 50 on the toy figure mounting unit 15, while the player possessing no toy figure can select “no toy figure” by touching the touch panel 3a. When the toy FIG. 50 is mounted on the toy figure mounting unit 15, the IC chip reader/writer 42 reads the toy figure ID, and the read toy figure ID is sent from the IC chip reader/writer 42 to the main CPU 32. On the other hand, when “no toy figure” is selected, a position signal issued with the selection is sent from the touch panel 3a to the main CPU 32.

In the subsequent step 22, the main CPU 32 determines whether the toy figure ID has been read or “no toy figure” has been selected. If the toy figure ID has been received from the IC chip reader/writer 42, the main CPU 32 determines that the toy figure ID has been read, and then proceeds to step 23. If the position signal issued with the selection of “no toy figure” has been received from the touch panel 3a, the main CPU 32 determines that “no toy figure” has been selected, and then terminates the toy figure information read process.

In step 23, the main CPU 32 operates as an update unit to perform a history creation/update process. In the history creation/update process, the main CPU 32 sets the received toy figure ID to a search key and performs a search for an appropriate record by referring to the history management file 80 (see FIG. 12). If the appropriate record exists, the main CPU 32 performs the update process in which the use frequency is updated by adding “1” to the number value of the record in the use frequency field 80c. In the embodiment, the toy figure ID of the toy FIG. 50 (see FIG. 2) mounted on the toy figure mounting unit 15 is “B2021”, and the number value in the use frequency field 80c is “65”. Therefore, the main CPU 32 performs the use frequency update process to the record corresponding to the toy figure ID “B2021” and thus changes the number value in the use frequency field 80c to “66” (see the asterisked number in FIG. 12). If there is no record corresponding to the toy figure ID inputted to the main CPU 32, the main CPU 32, regarding the toy figure of this toy figure ID as being used for the first time, creates a new record having “1” as the number value in the use frequency field 80c.

When the process proceeds to the subsequent step 24, the main CPU 32 writes predetermined information (e.g., “9”) to a read flag, and then terminates the toy figure information read process. This read flag indicates whether the toy figure ID has been read or not, i.e., indicates that the toy figure ID has been read by writing “9”.

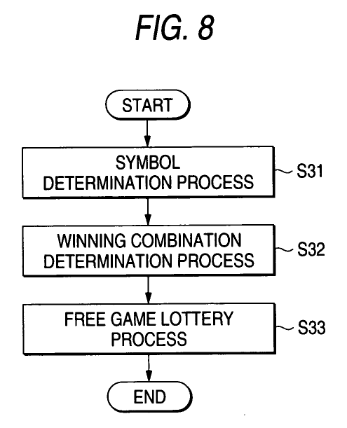

Next, the process proceeds to step 3 shown in FIG. 6 to perform the lottery process. When the lottery process is started, the process proceeds to step 31 shown in FIG. 8, wherein a symbol determination process is performed by the main CPU 32. In this symbol determination process, the main CPU 32 operates as the symbol determination unit to determine symbols to be displayed stopped by stopping variable display in the variable display windows 3A to 3I (which symbols are henceforth called “stop symbols”). In the slot machine 1A, during this lottery process, the main CPU 32 instructs the image control circuit 71 to display on the subsidiary display 4 an image for providing the game with an effect.

In this lottery process, having detected a player's start operation based on a start signal from the START button 5f, in response to the detection (i.e., in response to the start of the game), the main CPU 32 instructs the random number generator 35 to generate a set range of random numbers. In addition, the main CPU 32 instructs the sampling circuit 36 to extract any random number from among the random numbers generated by the random number generator 35. When the random number is extracted, the main CPU 32 sets the random number to a search key and acquires an appropriate symbol code number by referring to a not-shown symbol determination table (in which symbol code numbers and random numbers are stored related to each other) which is stored in the ROM 34.

Next, the main CPU 32 sets the acquired code number to a search key and performs a search for stopped symbols to be displayed stopped in the respective variable display windows 3A to 3I, by referring to a not-shown stop table (in which symbol code numbers and stop symbols are stored related to each other) which is stored in the ROM 34.

Then, in the slot machine 1A, the extraction of a random number and the search of both the symbol determination table and the stop table are performed for each of the variable display windows 3A to 3I, a total of nine times. That is, each table search is performed a number of times corresponding to the number of variable display windows, thus determining stop symbols for the respective variable display windows 3A to 3I.

Having determined the stop symbols for the respective variable display windows 3A to 3I, the main CPU 32 determines whether a winning combination is obtained or not, by referring to a winning combination determination table stored in the ROM 34. In the winning combination determination table, winning symbol patterns and non-winning symbol patterns are distinguishably registered and related to the combinations of code numbers (henceforth called “code number patterns”). After a code number pattern corresponding to the stop symbols is determined in step 31, the main CPU 32 operates as winning combination determination unit to set the code number pattern corresponding to the stop symbols to a search key. The main CPU 32 then refers to the winning combination determination table, and determines from the reference result whether the variable display game has been won or not.

Subsequently, the main CPU 32 performs a winning state determination process for determining a winning state (which is also called a “winning combination”) by referring to a state table. The state table, which is used to determine the states (winning states) in which winning combinations are obtained, registers awards corresponding to the winning states.

Subsequent to step 32, the process proceeds to step 33 to perform a bonus game lottery process. In the bonus game lottery process, when the stop symbol of the variable display window 3E (see FIG. 11) is a Wild Joker 92, it is determined in a to-be-described step 5 that the transition condition for making a transition to the bonus game has been fulfilled, thus causing the gaming mode to make a transition to the special gaming mode. Therefore, a lottery for determining the content of a bonus game, to be executed after a transition is made to the special gaming mode, is performed in the bonus game lottery process. Specifically, the main CPU 32 performs a predetermined table search and determines the number of times that the bonus game is to be executed after a transition is made to the special gaming mode. Furthermore, the main CPU 32 determines stop symbols in each bonus game by referring to the aforementioned stop table, determines whether or not a winning combination is obtained in each bonus game by referring to the winning combination determination table, and determines a winning state in each bonus game. Thereafter, the lottery process is terminated.

The Wild Joker 92, which, when displayed, offers to the player a greater advantage than any other symbol, is configured by combining an image showing a joker's face and a character string “WILD” as shown in FIG. 11.

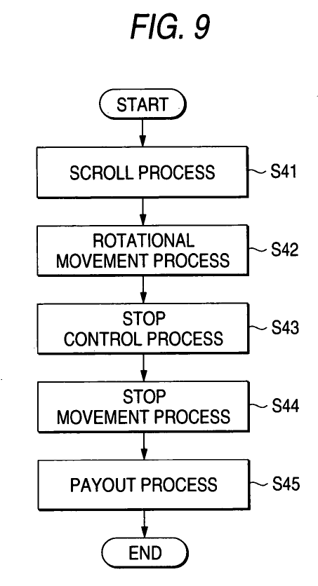

After the lottery process is terminated, the process proceeds to step 4 shown in FIG. 6 to perform a base game process. When the base game process is started, the process proceeds to step 41 shown in FIG. 9 to perform a scroll process, wherein an image such as shown in FIG. 11 is displayed on the main display 3. At this point, the aforementioned nine variable display windows 3A to 3I are displayed on the main display 3. In addition, a title display portion 83 including a character string “BONUS SPIN” and gaming instructions is displayed above the variable display windows 3A to 3I. Displayed below the variable display windows 3A to 3I is a meter display portion 84 having a BET display portion 84a for displaying a number of bets, a PAID display portion 84b for displaying a number of coins paid, an INSERT COIN/BET display portion 84c, and a CREDIT display portion 84d for displaying the number of credits. Eight BET display portions 82a for displaying a number of bets placed on each pay line are arranged surrounding the periphery of the variable display windows 3A to 3I.

After the game starts, the scroll process of variably displaying symbols in the variable display windows 3A to 3I on the main display 3 is performed in accordance with an instruction from the main CPU 32.

In the subsequent step 42, the main CPU 32 operates as a control unit of the invention to perform a rotational movement process. In the rotational movement process, the main CPU 32 determines whether the toy figure ID has been read or not. If “9” has been written to the read flag, the main CPU 32 determines that the toy figure ID has been read and thus instructs the movement control circuit 73 to drive the motor 62, thus controlling the rotation of the rotary shaft 61. The motor 62 thereby generates power to move the movable pedestal 15a, and the power is transmitted to the movable pedestal 15a by the rotation of the rotary shaft 61. This rotates the toy figure 50 set on the movable pedestal 15a. The toy FIG. 50 of the embodiment is configured to be mounted on the toy figure mounting unit 15, but is not a component provided in the slot machine 1A. That is, the slot machine 1A is configured to be capable of performing the notification of the normal gaming mode using the configuration not part of the machine itself. In addition, the toy FIG. 50, which is three-dimensional, is likely to appeal to the eye of the player unlike a two-dimensional image display. Moreover, the toy FIG. 50 makes an unprecedented rotational movement, and therefore looks innovative to the eye of the player. Thus, the toy FIG. 50 can be provided with variation in its movement, such as in rotation direction and speed, and is therefore configured to provide variety in notification.

Conversely, if “9” has not been written to the read flag, the process proceeds to step 43 without rotating the movable pedestal 15a.

When the process proceeds to step 43, a stop control process is performed, wherein stop symbols corresponding to the result of the lottery process in step 2 are displayed on the respective variable display windows 3A to 3I while the speed of scrolling is gradually being reduced.

In the subsequent step 44, the main CPU 32 operates as the control unit to perform a movement stopping process. In the movement stopping process, the main CPU 32 determines whether or not “9” has been written to the read flag. If “9” has been written to the read flag, the main CPU 32 instructs the operation control circuit 73 to stop the driving of the motor 62, and thus exerts control in stopping the transmission of power to the movable pedestal 15a via the rotary shaft 61. The main CPU 32 then clears the read flag and proceeds to step 45.

Conversely, if “9” has not been written to the read flag, the rotary shaft 61 is stopped, and the process therefore proceeds directly to step 45.

In the next step 45, when a winning combination has been obtained, a number of coins equivalent to the winning state are paid out, and the base game process is then brought to an end.

In the base game process, the movable pedestal 15a is thus controlled as to its rotation (rotated at a set speed and stopped) in response to the process of the base game in the normal gaming mode, when “9” has been written to the read flag, i.e., when the toy figure ID has been read.

When the base game process is terminated, the process proceeds to step 5, wherein the main CPU 32 determines whether the transition condition for allowing the gaming mode to make a transition to the special gaming mode has been fulfilled or not, based on the result of the symbol determination process in step 3. If the transition condition has been fulfilled, i.e., “if the stop symbol in the variable display window 3E is the Wild Joker 92,” the main CPU 32 operates as a transition unit to allow the gaming mode to make a transition to the special gaming mode, and then proceeds to step 6 to perform a bonus game notification process before a bonus game process (step 7).

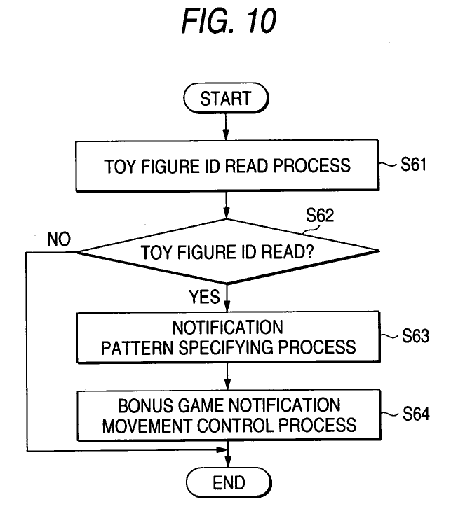

In the bonus game notification process, the process proceeds to step 61 in FIG. 10, wherein the IC chip reader/writer 42 reads the toy figure ID again. The read toy figure ID is transmitted to the main CPU 32, and the process then proceeds to step 62.

In the subsequent step 62, the main CPU 32 determines whether the toy figure ID has been read or not. If the toy figure ID has been received, the main CPU 32 determines that the toy figure ID has been read and then proceeds to step 63. If the toy figure ID has not been received, the main CPU 32 determines that the toy figure ID has not been read and thereafter terminates the bonus game notification process. By thus reading the toy figure ID again, the movable pedestal 15b can be prevented from moving unnecessarily in the case in which no toy FIG. 50 has been set.

When the process proceeds to step 63, a notification pattern specifying process is performed. In the notification pattern specifying process, the main CPU 32 sets the received toy figure ID to a search key by referring to the history management file 80 (see FIG. 12) in the data storage section 41, and then acquires the use frequency of an appropriate toy FIG. 50. Here, the use frequency acquired refers to the use frequency obtained after the main CPU 32 operates as the update unit to perform the update process in the aforementioned step 23. Thereafter, the main CPU 32 sets the acquired use frequency to a search key, and then determines a notification pattern corresponding to the process of the game (in the embodiment, before the bonus game is executed) by referring to the notification pattern table 81 (see FIG. 13) stored in the ROM 34. The notification pattern table 81 is prepared for each type of toy figure (such as the “wizard” or the “warrior”) in response to the progress of the game. As shown in FIG. 13, the notification pattern table 81 has a use frequency range field 81a and a notification pattern field 81b in which notification patterns (movement patterns of the movable pedestal 15a) are stored related to use frequency ranges, differentiated from one another in the use frequency range field 81a.

In the use frequency range field 81a are registered the use frequencies differentiated from one another for each set range (use frequency range), while in the notification pattern field 81b are registered five different kinds (01, 02, 03, 04, and 05) of notification patterns related to the use frequency ranges. For example, in the case of the notification pattern “01” corresponding to the use frequency range “1 to 30”, the movable pedestal 15a merely rotates five times at a low speed and stops. In the case of the notification pattern “02” corresponding to the use frequency range “31 to 100”, the movable pedestal 15a rotates ten times at a low speed. In the case of “03”, the movable pedestal 15a rotates 20 times at a high speed, in the case of “04” it rotates three times in one direction and thereafter three times in the opposite direction, in the case of “05” it rotates alternately in one direction and in the opposite direction repeatedly five times in each direction, and so on. And, in the embodiment, the movement pattern of the movable pedestal 15a is configured to become more complicated as the use frequency increases.

The movement pattern is thus varied depending on the use frequency, thereby enabling a diversity of effects for notification of the bonus game and an increase in the entertainment of the game. Particularly, when the movement pattern is made more complicated as the use frequency increases, this can encourage the player to use the same toy figure repeatedly, thereby making it possible to increase a player's attachment to the toy figure and thus to increase the player's willingness to collect the toy figures.

When the process proceeds to the subsequent step 64, the main CPU 32 operates as the control unit to perform a bonus game notification movement control process, and thus terminates the bonus game notification process. In the bonus game notification movement control process, based on the notification pattern determined in step 63, the main CPU 32 instructs the movement control circuit 73 to drive the motor 62, and controls the rotational movement of the movable pedestal 15a, thus notifying the player of the transition to the bonus game using the rotational movement of the toy FIG. 50. In the embodiment, the toy figure ID is “B2021”, the use frequency is “66” referring to the history management file 80 shown in FIG. 12, and furthermore the notification pattern is “02” referring to the notification pattern table 81 shown in FIG. 13. Here, when the notification pattern “02” indicates, for example, that “the toy FIG. 50 is rotated ten times at a set rotational speed,” first, power to move the movable pedestal 15a is generated by the driving of the motor 62, and the power is transmitted to the movable pedestal 15a by the rotary shaft 61, thus starting the set-speed rotational movement of the toy FIG. 50 set on the movable pedestal 15. Thereafter, the driving of the motor 62 is stopped after a predetermined time elapses to rotate the rotary shaft 61 ten times, thereby exerting control so as to stop the transmission of power by the rotary shaft 61, and the rotation of the movable pedestal 15a and the rotation of the toy FIG. 50 are thus stopped.

In the bonus game notification movement control process, based on the notification pattern determined in step 63, the main CPU 32 thus controls the driving of the motor 62 to control the rotational movement of the rotary shaft 61 which is the power transmission mechanism. The toy FIG. 50 is thereby made to perform a predetermined rotational movement, thus notifying the player of the transition to the bonus game. That is, the slot machine 1A is configured to be capable of using a component not part of the machine itself to perform the notification of the game progress which is at the stage before the execution of the bonus game. In addition, similar to the aforementioned notification of the game progress in the base game, the toy FIG. 50 is three-dimensional, and is therefore likely to appeal to the eye of the player, and the notification is performed using the toy FIG. 50, which therefore looks innovative to the eye of the player. Furthermore, the toy FIG. 50 can be provided with variation in its movement, such as in the rotation direction and speed of the toy FIG. 50, and is therefore configured to provide a variety in notification.

When the bonus game notification process is terminated, the process proceeds to step 7 shown in FIG. 6 to perform the bonus game process. In the bonus game process, the main CPU 32 performs a free spin variable display game which requires no input from the player to start and stop the game, in accordance with the result of a bonus game lottery in step 33 (see FIG. 8), and thereafter ends the game.

In the embodiment, when the toy figure ID has been read, the transmission of power by the rotary shaft 61 is thus controlled in response to the progress of the slot game which is at the stage before the execution of the bonus game (ready to execute the bonus game), and in particular the rotational movement is controlled based on the use frequency corresponding to the toy figure ID.

As described above, in the slot machine 1A according to the first embodiment, the notification is made of the game progress (such as during the symbol scroll process or before the execution of the bonus game) by the effect of rotationally moving the toy FIG. 50, which is a component not part of the machine itself. Therefore, the notification effect can easily be diversified by varying a movement pattern such as the rotational direction, the number of rotations, and the rotational speed of the toy FIG. 50. Additionally, in the embodiment, the movement pattern is varied based on the use frequency corresponding to the toy figure ID, which therefore makes it unlikely for the player to become tired of the notification effect. Furthermore, the movement pattern is configured to become more complicated as the use frequency increases, thereby enabling a different effect configured such that the player will be able to enjoy a complicated movement pattern by continuously using the same toy figure. This makes it possible to encourage the player to use the same toy figure, which also yields the advantage of leading the player to have an attachment to the toy figure, thus encouraging the player to collect toy figures.

### Second Embodiment

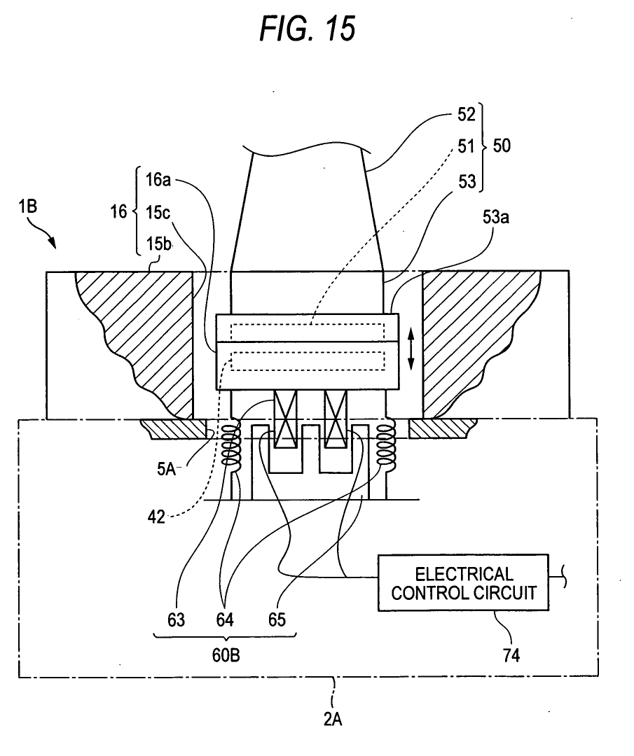

A slot machine 1B according to a second embodiment will subsequently be described with reference to FIG. 15. The slot machine 1B according to the second embodiment has a common basic configuration with the aforementioned slot machine 1A. Therefore, common parts are identified by similar reference numerals to omit their description, and a description will be given mainly of differing parts. A toy figure mounting unit 16 of the slot machine 1B is also configured capable of holding a toy FIG. 50 so that the toy figure ID can be read by an IC chip reader/writer 42, and capable of moving while holding the toy FIG. 50. The toy figure mounting unit 16 has a vibratory movable pedestal 16a which can vibrate with the toy FIG. 50 supported thereon and a frame 15b which, provided surrounding the movable pedestal 16a, supports the toy FIG. 50. The movable pedestal 16a vibrates by operation of a drive device 60B.

More specifically, the movable pedestal 16a, formed into a thick disk shape, has one end face (upper surface) which supports a seat 51 of the toy FIG. 50 and the other end face (lower surface) to which is set a coil 63 through which the conduction of AC electricity is permitted.

The drive device 60B includes the aforementioned coil 63, an elastic portion 64, and a magnetic circuit 65 provided with an annular permanent magnet surrounding the coil 63. In addition, an electrical control circuit 74 to be connected to the coil 63 is connected to the main CPU 32 via the I/O port 39 and permits the conduction of a predetermined DC or AC current through the coil 63 in accordance with an instruction from the main CPU 32.

According to the toy figure mounting unit 16 and the drive device 60B which have the respective aforementioned configurations, when the main CPU 32 instructs the electrical control circuit 74 to permit the conduction of the predetermined DC or AC current through the coil 63, electricity which acts in a direction perpendicular to magnetic field lines in the magnetic circuit 65 (i.e., in an up and down direction), is generated, and power acting in an up and down direction is transmitted to the movable pedestal 16a. Furthermore, the main CPU 32 instructs the electrical control circuit 74 to periodically vary the direction of the current whose conduction is permitted through the coil 63, and moreover the variation cycle of the current direction can be lengthened. This enables up-and-down movement control for moving the movable pedestal 16a up and down. The variation cycle can be shortened, thereby enabling vibrational movement control for vibrating the movable pedestal 16a up and down. In the embodiment, the drive device 60B corresponds to the actuating unit, and the coil 63 and the magnetic circuit 65 double as the power generator for generating power to move the movable pedestal 16a and the power transmission mechanism.

As described above, in the slot machine 1B of the embodiment, the main CPU 32, via the electrical control circuit 74, exerts the up-and-down movement control or the vibrational movement control over the movable pedestal 16a by changing the timing in switching the magnitude or polarity of the DC or AC current whose conduction is permitted through the coil 63. That is, in place of the rotational movement in the slot machine 1A, the player is notified of the game progress by the up-and-down or vibrational movement of the toy FIG. 50 which responds to the game progress.

As described above, the slot machine 1B of the embodiment also exerts the same advantages as the aforementioned slot machine 1A. Thus, the notification effect can easily be diversified by varying a movement pattern such as the up-and-down movement speed and the vibration period of the toy FIG. 50.

The power transmission mechanism for transmitting power to the movable pedestal is not limited to the aforementioned rotary shaft 61, the coil 63 and the magnetic circuit 65, or the like. For example, a pinion-rack up-and-down movement mechanism can be configured as the power transmission mechanism for the movable pedestal, and the up-and-down movement speed thereof can be changed, or the number of times in which the up-and-down movement thereof is repeated can be changed, thereby making it possible to provide the notification effect with diversity.

### Third Embodiment

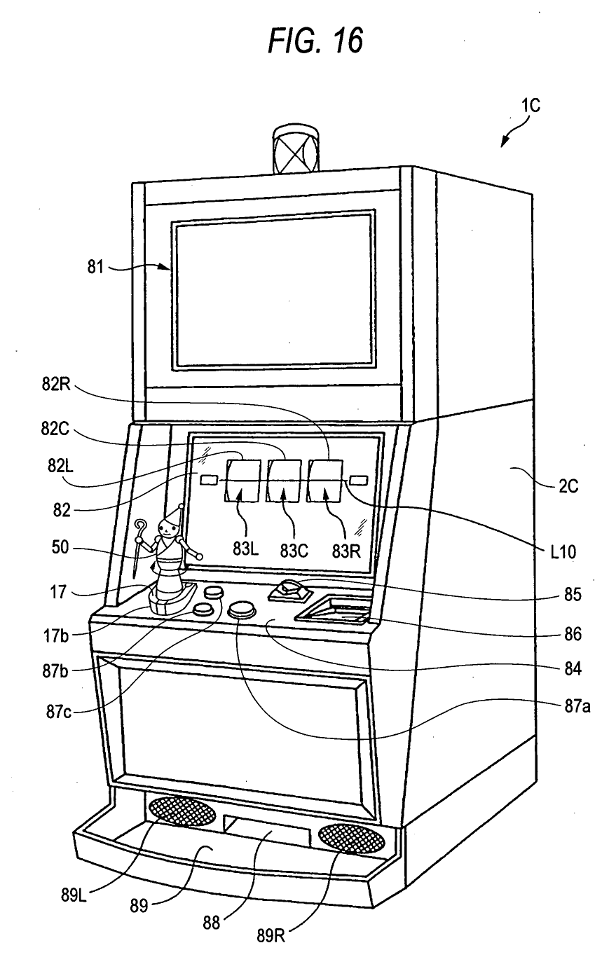

A slot machine 1C according to a third embodiment will subsequently be described with reference to FIG. 16. FIG. 16 is a perspective view showing the overall configuration of the slot machine 1C of the embodiment. The slot machine 1C, having variable display unit for variably displaying a plurality of symbols, is configured capable of using the variable display unit to perform a variable display game (slot game) which uses the variable display of the plurality of symbols. Similar to the slot machines 1A and 1B, the slot machine 1A has a normal gaming mode in which a base game can be performed and also a special gaming mode in which a bonus game, which is started under predetermined conditions subsequent to the base game, can be performed, and is thus configured to be capable of performing the variable display game in the special gaming mode as well as in the base game mode. And, when a toy figure ID has been read, the movement of a to-be-described toy figure mounting unit 17 (movable pedestal) is controlled in response to the progress of the game, based on history information (use frequency) corresponding to the toy figure ID, thus notifying the player of a game process, such as during the base game or before the bonus game. The configuration of the slot machine 1C will be described in detail below.

The slot machine 1C has, on the front side of a cabinet 2C, an image display 81 and a symbol display 82 in the order named from the top. The symbol display 82 is vertically located in the approximately central portion of the cabinet 2C. Inside the cabinet 2C, three mechanical reels 83L, 83C, and 83R are rotatably arranged in a horizontal row in response to three display windows 82L, 82C, and 82R formed in the symbol display 82.

The reels 83L, 83C, and 83R are rendered visible from the outside through the display windows 82L, 82C, and 82R. A symbol column (not shown) having plural kinds of symbols is displayed on the periphery of each of the reels 83L, 83C, and 83R. The reels 83L, 83C, and 83R, each configuring variable display unit rotatable so as to variably display the symbols, rotate at a set speed (e.g., 80 revolutions per minute).

As shown in FIG. 16, one pay line L10 extending horizontally is provided on the display windows 82L, 82C, and 82R relative to the reels 83L, 83C, and 83R.

An approximately horizontal operation platform 84 is provided below the symbol display 82. The operation platform 84 is provided with the toy figure mounting unit 17, a coin insertion slot 85, a bill insertion slot 86, a SPIN switch 87a, a 1-BET switch 87b, and a MAX-BET switch 87c.

The toy figure mounting unit 17, which corresponds to the movable holding unit of the invention, has the movable pedestal, a frame 17b, and an IC chip reader/writer, and the like. Similar to the aforementioned toy figure mounting units 15 and 16 of the slot machines 1A and 1B, the toy figure mounting unit 17 holds a toy FIG. 50 so that the toy figure ID can be read by the IC chip reader/writer, and can move while holding the toy FIG. 50.

The coin insertion slot 85 and the bill insertion slot 86 are provided for the player to insert coins and bills, respectively, to be bet in the game. The SPIN switch 87a is provided to start the symbol variable display by rotation of the reels 83L, 83C, and 83R in the display windows 82L, 82C, and 82R. The 1-BET switch 87b is provided for placing the bet of one coin in a single operation. The MAX-BET switch 87c is provided for placing the bet of the maximum number of coins that can be bet on one game in a single operation. In addition, a coin payout opening 88 is provided at the bottom of the cabinet 2C, and speakers 89L and 89R are provided on the left and right sides of the payout opening 88.

Similar to the slot machines 1A and 1B, the slot machine 1C includes: a microcomputer which, having a main CPU, a RAM, a ROM, and the like, controls the operation of the entire slot machine 1C; a data storage section for storing a history management file; the IC chip reader/writer for reading the toy figure ID from the toy FIG. 50 mounted on the toy figure mounting unit 17; a power generator for generating power to move the movable pedestal; and a power transmission mechanism for transmitting the power generated by the power generator. The main CPU operates as the game progress control unit of the invention to control the progress of the variable display game and the control unit of the invention to control the transmission of power by the power generator and the power transmission mechanism. In addition, the main CPU creates and updates the history management file.

As described above, the slot machine 1C according to the third embodiment exerts the same advantages as the aforementioned slot machines 1A and 1B. Thus, the movement pattern of the toy FIG. 50 is varied, thereby making it possible to easily diversify the notification effect.

### Fourth Embodiment

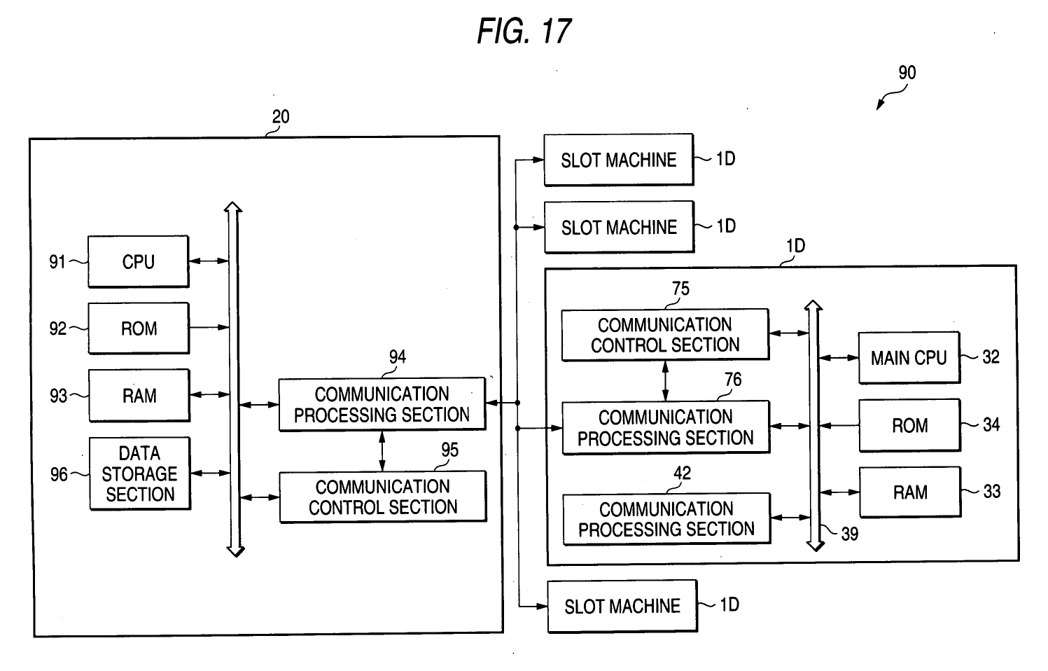

A description will subsequently be given of a fourth embodiment of a gaming system of the invention. FIG. 17 is a block diagram showing the outlined configuration of the gaming system of the fourth embodiment. A gaming system 90 having a server 20 installed in a game arcade and a plurality (in the embodiment, four) of slot machines 1D communicably connected to the server 20. In the game arcade, the server 20 and the slot machines 1D, having a dedicated connection to one another, form an in-house LAN.

The server 20 serves as a game server and each of the slot machines 1D serves as the gaming machine. As in the aforementioned slot machines 1A and 1B of the first and second embodiments, each of the slot machines 1D, having a plurality of variable display windows for displaying a plurality of symbol variable display images, is configured capable of performing a variable display game (also called slot game) which uses the variable display images displayed in the respective variable display windows.

As in the aforementioned slot machine 1C of the third embodiment, the slot machines 1D may be each configured to have variable display unit for variably displaying a plurality of symbols, and configured capable of using the variable display unit to perform a variable display game which employs the variable display of the plurality of symbols. In this case, the gaming machine includes a communication processing unit for transmitting/receiving data from a game server, and a main CPU operates as the game progress control unit for controlling the variable display game which uses the plurality of symbols variably displayed.

The server 20 has a CPU 91, a ROM 92, a RAM 93, a communication processing section 94, a communication control section 95, and a data storage section 96 which stores a history management file. The CPU 91 corresponds to the update unit of the invention, and the communication processing section 94 and the communication control section 95 correspond to the communication processing unit of the game server of the invention.

The CPU 91 operates while reading/writing data to the RAM 93 in accordance with a program stored in the ROM 92, while the communication control section 95 activates the communication processing section 94 in accordance with the instruction of the CPU 91, thus transmitting/receiving data from the slot machines ID. Furthermore, the CPU 91 creates and updates the record of the history management file, based on a toy figure ID transmitted from each slot machine ID. The history management file, having the same configuration as that described in the aforementioned slot machine 1A, has a record consisting of a toy figure ID field, a toy figure type field, and a use frequency field. Data recorded in this record corresponds to the history information of the invention.

Each slot machine 1D, while having a communication processing section 75 and a communication control section 76, is different from the aforementioned slot machines 1A and 1B in that it has no data storage section. The communication processing section 75 and the communication control section 76 are connected to the main CPU 32 via an I/O port 39, and the communication section 76 activates the communication processing section 76 in accordance with the instruction of the CPU 91 and thus transmits/receives data from the server 20. In addition, similar to the aforementioned slot machine 1A, the slot machines 1D also each include a toy figure mounting unit 15 (a movable pedestal 15a and a frame 15b), an IC chip reader/writer 42, a drive control circuit 73, a motor 62 serving as the power generator, a rotary shaft 61 serving as the power transmission mechanism, and the like. The communication processing section 75 and the communication control section 76 correspond to the communication processing unit of the gaming machine of the invention, and the main CPU 32 operates as the game progress control unit and the control unit of the invention. Furthermore, the toy figure mounting unit 15 (not shown) corresponds to the movable holding unit, and the IC chip reader/writer 42 corresponds to the readout unit. Since the other configurations of each of the slot machines 1D are covered by the configuration common with the aforementioned slot machines 1A and 1B, like components are identified by like reference numerals, thus the description is omitted.

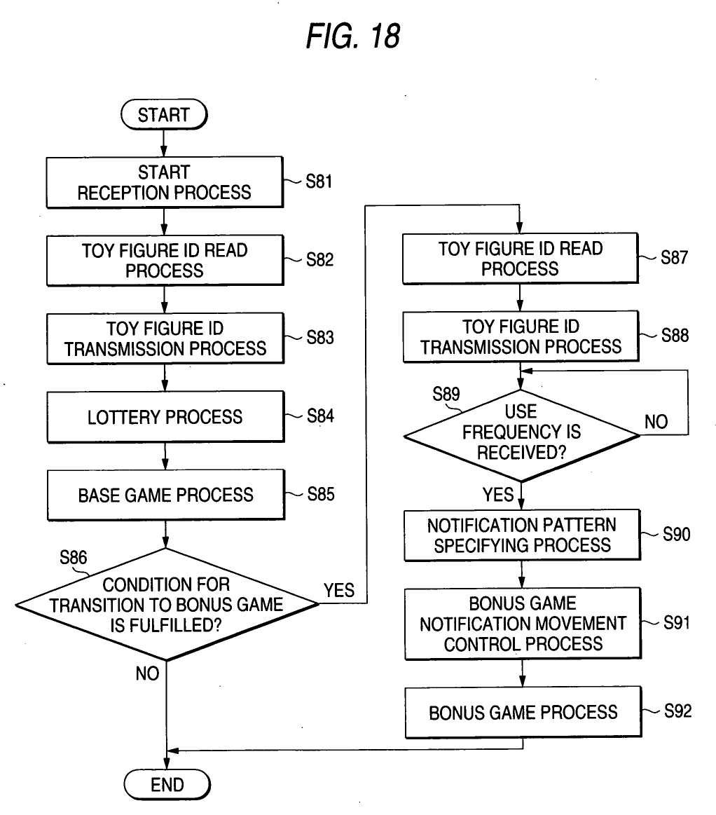

The operation of the gaming system 90 having the aforementioned configuration will be described with reference to a flowchart shown in FIG. 18, focusing on the operation of each of the slot machines 1D. FIG. 18 is a flowchart showing the operation of each of the slot machines 1D in a main process from the start to the end of the game, wherein one of the plurality of slot machines 1D installed in the game arcade is described as an example. In addition, when the following description falls under the same operation as in each process described in the aforementioned slot machine 1A, a detailed description will be omitted by using similar process names. Furthermore, in FIG. 18, the term step is abbreviated as “S”.

In the gaming system 90, the main CPU 32 of the slot machine 1D operates as the game progress control unit of the invention to control the progress of the game. As shown in FIG. 18, when the main process is started, at the start of the game, in step 81, a start reception process is performed. In the subsequent step 82, a toy figure ID read process is performed, and the process proceeds to the subsequent step 83. In the toy figure ID read process, the IC chip reader/writer 42 reads the toy figure ID of a toy FIG. 50 mounted on the toy figure mounting unit 15, and sends the read toy figure ID to the main CPU 32.

In the subsequent step 83, the main CPU 32 instructs the communication control section 75 to transmit the received toy figure ID from the communication processing section 76 to the game server 20. In the game server 20, upon receiving the toy figure ID, the CPU 91 operates as the update unit of the invention to perform a history creation/update process for creating or updating the record of the history management file stored in the data storage section 96. In the history creation/update process, the CPU 91 sets the transmitted toy figure ID to a search key and performs a search for an appropriate record by referring to the history management file. If the appropriate record is present, the CPU 91 performs a use frequency update process in which “1” is added to the number value of this record in the use frequency field. If the appropriate record is absent, the main CPU 32, regarding the toy figure of this toy figure ID as being used for the first time, creates a new record having “1” as its number value in the use frequency field.

When the process proceeds to the subsequent step 84, a lottery process is performed in the slot machine 1D. When the process proceeds to the subsequent step 85, a base game process is performed, and the process then proceeds to step 86.

When the process proceeds to step 86, it is determined whether the transition condition for making a transition to the bonus game is fulfilled or not. If the transition condition is fulfilled, the process proceeds to step 87, while, if the transition condition is not fulfilled, the main process is terminated.

When the process proceeds to step 87, the IC chip reader/writer of the slot machine 1D reads the toy figure ID again, and the read toy figure ID is sent to the main CPU 32. If the toy figure ID has been received, it is determined that the toy figure ID has been read, and the process then proceeds to step 88.

When the process proceeds to step 88, a toy figure ID transmission process is performed, and the main CPU 32 instructs the communication control section 75 to transmit the toy figure ID from the communication processing section 76 to the game server 20. Upon receiving the toy figure ID, the game server 20 sets this toy figure ID to a search key and makes a search for an appropriate record by referring to the history management file stored in the data storage section 96, thus acquiring a use frequency. This use frequency refers to the use frequency having been subjected to the update process by the CPU 91 operating as the aforementioned update unit. Thereafter, the CPU 91 instructs the communication control section 95 to transmit the acquired use frequency, as history information, from the communication processing section 94 to the slot machine 1D.

In the slot machine 1D, in step 89, data indicative of a use frequency (frequency data) is awaited until received, and when received, the frequency data is sent from the communication processing section 75 to the main CPU 32. The process thereafter proceeds to the subsequent step 90 to perform a notification pattern specifying process. In the notification pattern specifying process, the main CPU 32 uses the frequency data to make a search for a notification pattern table stored in the ROM 34 and thus acquires an appropriate notification pattern.

When the process proceeds to the subsequent step 91, a bonus game notification process is performed, and the main CPU 32 operates as the control unit to control the movement of a movable pedestal 15a which responds to the acquired notification pattern. After the subsequent bonus game process (step 92), the main process is terminated.

As described above, according to the gaming system 90 according to the fourth embodiment, the player is notified of a game process (such as during a symbol scroll process in the base game or before the execution of the bonus game) using the effect of moving the toy FIG. 50 which is a component other than the slot machine 1D. The movement pattern of the toy FIG. 50 is varied, thereby making it possible to easily diversify the notification effect. In addition, the movement pattern is varied based on the use frequency corresponding to the toy figure ID, which therefore makes it unlikely for the player to become tired of the notification effect. The movement pattern is configured to become more complicated as the use frequency increases, thereby enabling a different effect configured such that the player will be able to enjoy a complicated movement pattern by continuously using the same toy figure. This makes it possible to encourage the player to use the same toy figure, which also yields the advantage of leading the player to have an attachment to the toy figure and thus encouraging the player to collect toy figures.

The gaming machine and gaming system according to the first to fourth embodiments have so far been described. However, the present invention is not limited to the aforementioned embodiments. For example, in the aforementioned embodiments, the game, which is performed by controlling the progress of the game related to the variable display game (slot game), has been described as an example, but the following games may be adopted: an image game such as a card game in which card images are displayed and a mahjong game in which mahjong tiles are displayed; an image game in which character images move in response to a player's input; and the like.

In addition, the drive transmission section may be configured to be controlled as to movement in response to the progress of the image game or the variable display game, based on the toy figure type (such as “wizard” or “warrior”) classified by the toy figure ID.

Furthermore, the history information is not limited only to the use frequency. For example, the following configuration may be adopted. That is, at the start and end of the main process of the game, the toy figure ID is read, and the time of day when the toy figure ID has been read is acquired, thus calculating the time period of use of the toy figure in one round of the game. Besides, the time periods, in which the toy figure has been used in a plurality of rounds of the game, are accumulated and stored in the history management file as cumulative use time. Thus, based on the cumulative use time, the movement of the drive transmission section is controlled in response to the progress of the image game or the variable display game.

Additionally, in the aforementioned embodiments, the management and update process of the history information are performed in the gaming machine and the game server. Alternatively, the configuration may be such that the history information is stored in the IC chip 53 of the toy FIG. 50, and thus such that the process of rewriting and updating the history information is appropriately performed by the IC chip reader/writer 42.

Furthermore, in the aforementioned embodiments, the movable holding unit is controlled as to movement using a predetermined notification pattern for notification of the transition to the bonus game. Alternatively, it is also possible, when no transition is made to the bonus game, to perform a false notification consisting of controlling the movement of the movable holding unit using a different notification pattern from the aforementioned notification pattern, and thus to perform an effect such that interest in the game is increased by intentionally betraying player's expectations.

Still furthermore, the aspect in which the identification information and the history information are stored in the reading object is not limited to a noncontact IC chip capable of having data read from it, but may be contact-type data storage unit. The following configuration may also be adopted. That is, instead of providing data storage unit such as a memory, an information display section having an information storage function is provided on the reading object in such a manner that a seal having a barcode or a two-dimensional code printed thereon is attached to the reading object, or that a barcode or a two-dimensional code are printed or stamped directly on the reading object. The reading object thus stores the identification information and the history information. The two-dimensional code is also called a two-dimensional barcode, which includes, for example, “QR Code” (the trademark of Denso Wave Incorporated). This two-dimensional code contains a large amount of information obtained by encoding data, and having a capacity tens of times to hundreds of times that of the barcode. To provide the information display section in such a manner, the aforementioned IC chip reader/writer is replaced with a barcode reader or the like as the read out unit.

### Fifth Embodiment

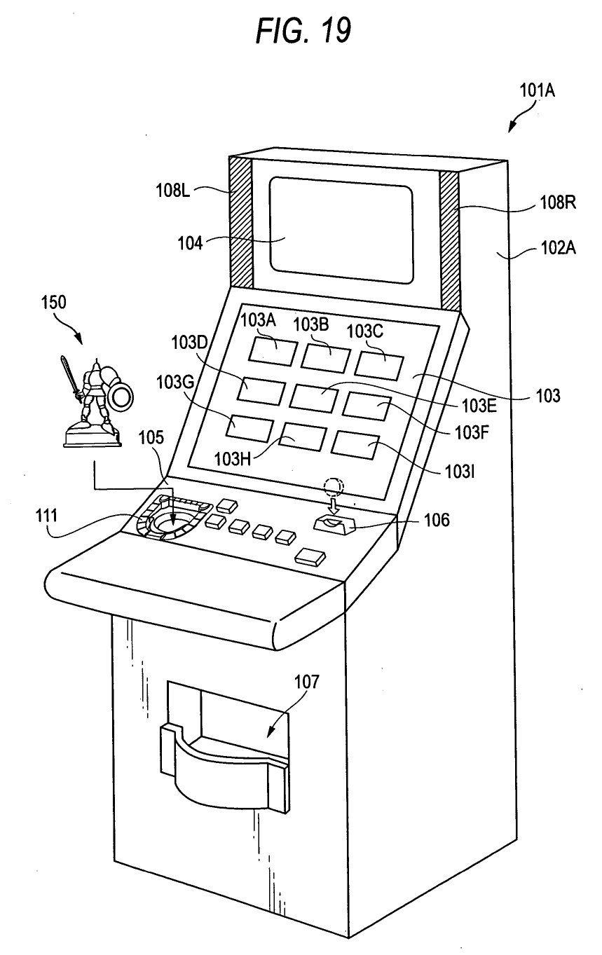

FIG. 19 is a perspective view showing the overall configuration of a slot machine 101A according to a fifth embodiment. The slot machine 101A, having a plurality of variable display windows for displaying a plurality of symbol variable display images, is configured to be capable of performing a variable display game (also called a slot game) which uses the variable display images displayed in the respective variable display windows. The variable display game includes a base game that is started without conditions from the start of the variable display game and a bonus game that is started under predetermined conditions subsequent to the base game. The slot machine 101A has a normal gaming mode in which the base game can be performed and also a special gaming mode in which the bonus game can be performed, and is thus configured to be capable of performing the variable display game in the special gaming mode as well as in the normal gaming mode.

The slot machine 101A, including a toy figure mounting unit 111 capable of having set on it a to-be-described toy figure 150, is configured as follows. That is, the toy figure 150 mounted on the toy figure mounting unit 111 is illuminated in response to the progress of the game (such as during the base game or before execution of the bonus game), and a player is notified of the progress of the game using a light effect resembling the toy figure 150 emitting light. The configuration of the slot machine 101A will be described in detail below.

The slot machine 101A has, on the front side of a cabinet 102A, a main display 103 provided with a liquid crystal display device. The slot machine 101A similarly has, in a portion thereof above the main display 103, a subsidiary display 104 provided with a liquid crystal display device. Speakers 108L and 108R for producing a sound to be used in a game effect are located on both left and right sides of the subsidiary display 104.

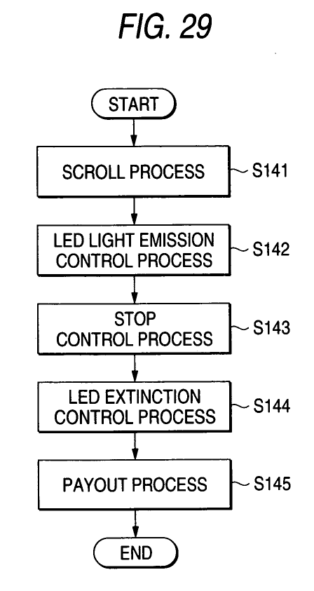

The main display 103 that serves as a display unit, has a total of nine variable display windows 103A, 103B, 103C, 103D, 103E, 103F, 103G, 103H, and 103I arranged in a three-by-three matrix. This main display 103 is configured such that scrolling display images (reel images displayed to resemble mechanical reels rotating) resembling a plurality of symbols moving downward are displayed in the variable display windows 103A to 103I both in the normal gaming mode and in the special gaming mode. As shown in FIG. 29, the slot machine 101A has the nine variable display windows 103A to 103I, and is therefore configured such that a total of eight activated lines (L1 to L8), arranged in a three-by-three matrix and diagonally, are set up on the nine variable display windows 103A to 103I.

Images not directly engaged in the game (e.g., description of a game content) are displayed on the subsidiary display 104.

In addition, the slot machine 101A has, below the main display 103, the toy figure mounting unit 111 on which the toy figure 150 is to be mounted, a control panel 105, and a coin insertion slot 106 into which are inserted coins to be bet on the game. A drive device 160 for moving a movable pedestal 115a of the toy figure mounting unit 115 is provided inside a cabinet 102A, and a coin receiving tray 107 for collecting coins paid out is provided in a lower portion of the cabinet 102A.

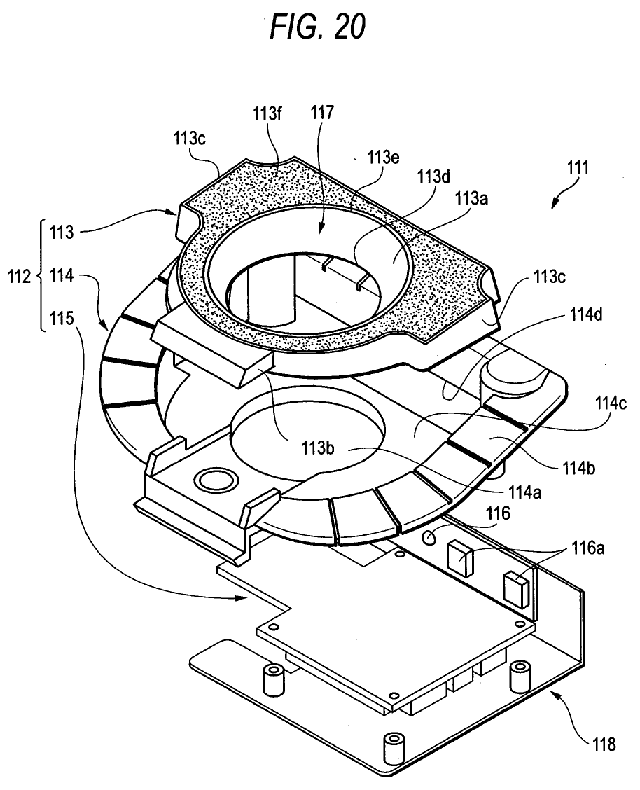

The toy figure mounting unit 111 will first be described with reference to FIG. 20. FIG. 20 is an exploded perspective view of the toy figure mounting unit 111. The toy figure mounting unit 111 has a full color LED 116 which emits light and a holder section 112 which is formed with a holding hole 117 for holding the toy figure 150 and is formed with a light transmission region between a peripheral wall surface 113a (see FIG. 20) of the holding hole 117 and the LED 116. And, an IC chip reader/writer 115 is incorporated into the holder section 112. The toy figure mounting unit 111 is thus configured to hold the toy figure so that a to-be-described toy figure ID can be read by the IC chip reader/writer 115, and to emit light so that the held toy figure 150 is illuminated with the light. The toy figure mounting unit 111 corresponds to the light emitting holding unit of the invention, and the IC chip reader/writer 115 corresponds to the read out unit of the invention. In addition, the full color LED 116 corresponds to the light source of the invention.

Specifically, as shown in FIG. 20, the holder section 112, having the holding hole 117 therein, has a holding member 113 made of a clear, colorless, light transmissive member of transparent urethane or the like, a holding frame 114 for holding the holding member 113 from around and below, and a base 118 for fixing the holding frame 114 to the cabinet 102A together with the holding member 113.

The holding member 113, formed into a generally annular shape having the holding hole 117 therein, has a projecting portion 113b provided on the front side (player's side), wide portions 113c and 113c provided so as to increase in width toward the back side, and a light shielding seal 113f adhered to the top surface (except the peripheral wall surface 113a forming the holding hole 117). The holding member 113 is held with the underside of the projecting portion 113b fitted to the holding frame 114 and with the wide portions 113c and 113c fitted against the holding frame 114.

The holding member 113 includes a circular opening 113d on the side of the holding hole 117 which faces the base 118 (i.e., on the side of the holding hole 117 which is closed by a fitting portion 114a of the holding frame 114) and a circular opening end 113e on the open side of the holding hole 117. The opening end 113e has a larger diameter than the opening 113d, and the peripheral wall surface 113a forms a cone-shaped incline which is continued, while being gradually reduced in diameter, from the opening end 113e toward the opening 113d. The opening 113d, which corresponds in shape to a seat 151 of the toy figure 150, is formed such that the seat 151 can be inserted therethrough.

The holding frame 114 includes an annular frame body 114b surrounding the holding member 113, a holding support 114c which, depressed inside this frame body 114b, holds the holding member 113, a light transmission window 114d formed in the back surface of the holding support 114c, and the fitting portion 114a which is depressed into a stepped cylindrical form, inside of and approximately in the center of the holding support 114c. The fitting portion 114a has a circular form concentric with and of the same diameter as the shape of the opening 113d of the holding member 113.

The IC chip reader/writer 115 that serves as a read out unit, includes on a convex substrate thereof an antenna, a wireless circuit, or the like. The antenna (not shown) is fixed to the base 118 so as to be located near the center of the bottom of the fitting portion 114a. The IC chip reader/writer 115 is configured to use this antenna to read the toy figure ID from a to-be-described IC chip 153 embedded in the toy figure 150. When the toy figure 150 is mounted on the toy figure mounting unit 111, the IC chip reader/writer 115 is also configured capable of writing predetermined information to the IC chip 153 of the toy figure 150 in accordance with an instruction of a main CPU 132.

The full color LED 116, including a red light emitting element, a blue light emitting element, and a green light emitting element, is controlled as to the light emission of each such light emitting element so as to emit various color lights. The full color LED 116 is disposed to the rear of the back side of the holding member 113 with a predetermined clearance (in the order of 5 mm) provided therebetween via clearance members 116a. The light emission of the light emitting elements is controlled by a to-be-described LED light emission control circuit 173.

As described above, the holding member 113 is made of the light transmissive member, and the light transmission window 114d is formed between the holding member 113 and the full color LED 116. Therefore, the configuration is such that the light transmission region is formed between the full color LED and the peripheral wall surface 113a of the holding member 113. In addition, the light shielding seal 113f is adhered to the top surface of the holding member 113. Therefore, the configuration is such that light emitted from the full color LED 116 passes through the light transmission window 114d and reaches the holding member 113, and further such that the light passes through the inside of the holding member 113 made of the light transmissive member and is emitted mainly from the peripheral wall surface 113a of the holding hole 117 to illuminate the toy figure 150. It is not necessary that all the interior portion of the holding member 113 be made out of the light transmission member. For example, the aspect may be such that the section of the holding member 113 which provides a linear connection between the peripheral wall surface 113a thereof and the full color LED 116 is made of the light transmissive member.

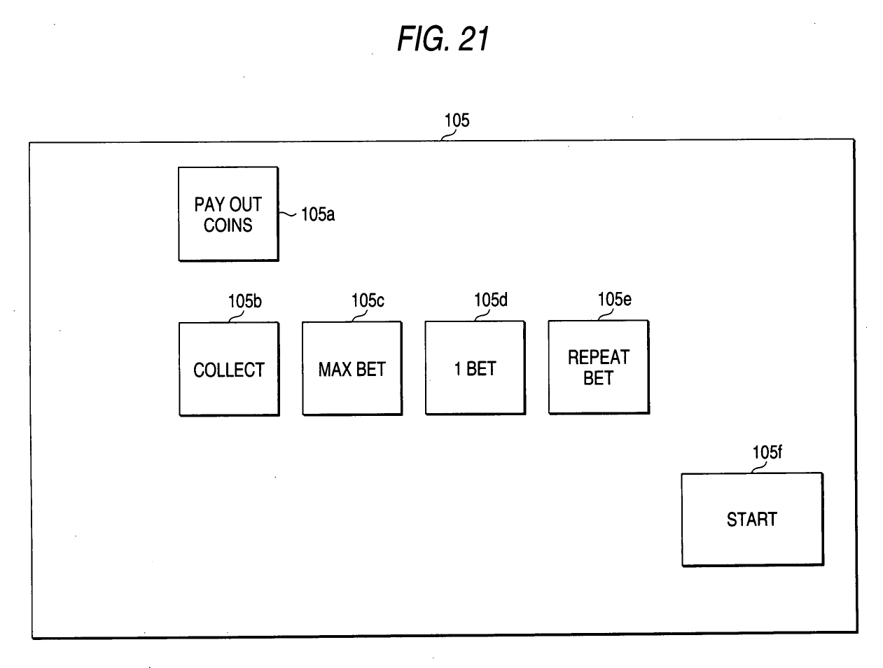

As shown in FIG. 21, the control panel 105 has a PAYOUT button 105a for instructing the payout of coins, a COLLECT button 105b for collecting coins won in the game, a MAX-BET button 105c for placing the bet of a maximum number of coins, a 1-BET button 105d for placing the bet of one coin, a REPEAT-BET button 105e for betting the same number of coins as in the previous game and giving an instruction to start the game, and a START button 105f for giving an instruction to start the game.

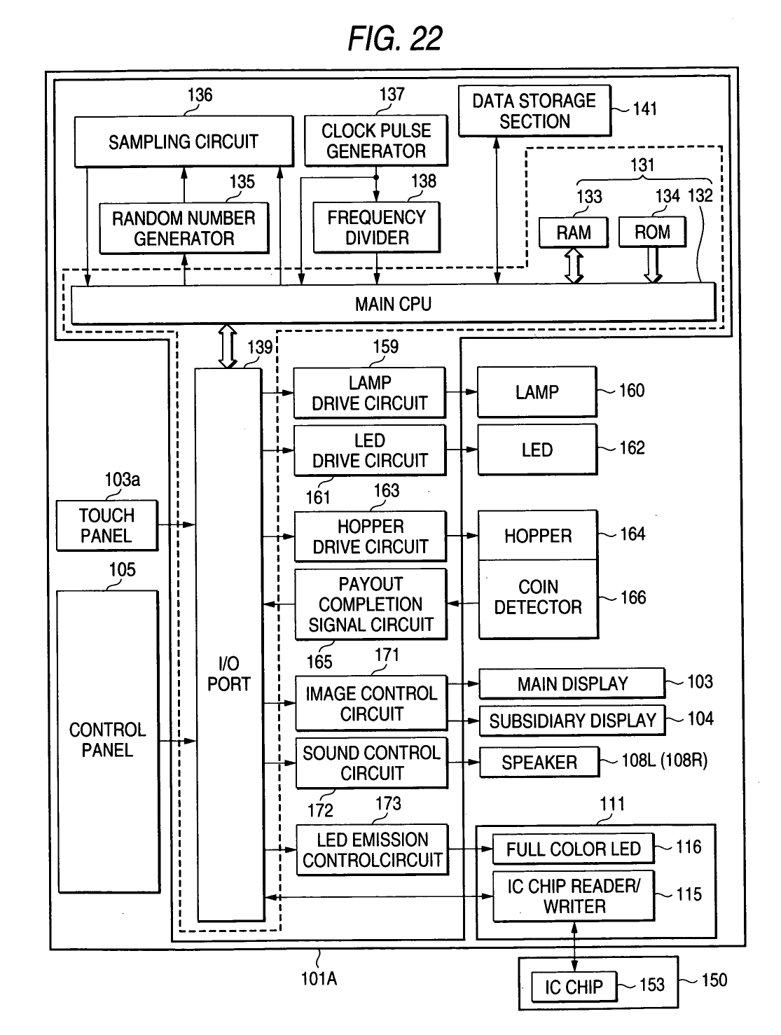

FIG. 22 is a block diagram of the slot machine 101A, showing its main internal configuration. The slot machine 101A has a plurality of components with a microcomputer 131 forming a core.

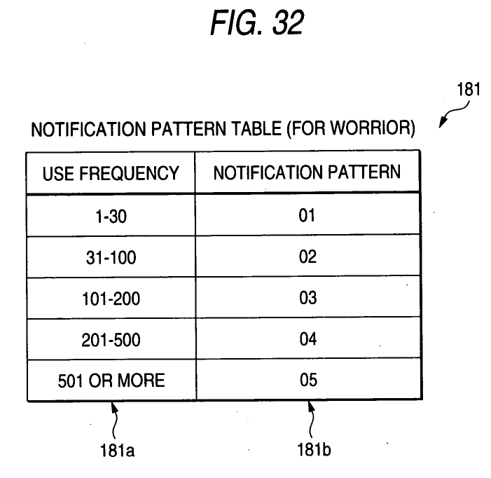

The microcomputer 131 has a main CPU (Central Processing Unit) 132, a RAM (Random Access Memory) 133, and a ROM (Read Only Memory) 134. The main CPU 132 operates in accordance with a program stored in the ROM 134 to receive signals from the sections of the control panel 105 via an I/O port 139 and at the same time to exchange signals with the other components, thus controlling the operation of the entire slot machine 101A. The RAM 133 stores data and a program which are used upon operation of the main CPU 132, for example, after the start of the game, the RAM 133 temporarily holds random number values sampled by a to-be-described sampling circuit 136. The ROM 134 stores a program to be executed by the main CPU 132 and permanent data, e.g., a to-be-described notification pattern table 181 (see FIG. 32).

The slot machine 101A has a random number generator 135, the sampling circuit 136, a clock pulse generator 137, a frequency divider 138, and a data storage unit 141. The random number generator 135 operates in accordance with the instruction of the main CPU 132 to generate a fixed range of random numbers. The sampling circuit 136 extracts any random number from the random numbers generated by the random number generator 135 and transmits the extracted random number to the main CPU 132. The clock pulse generator 137 generates a reference clock for operating the main CPU 132, and the frequency divider 138 transmits, to the main CPU 132, signals obtained by dividing the reference clock by a fixed frequency. The data storage unit 141 stores a to-be-described history management file 180 in response to the toy figure ID of the toy figure 150, and serves as a storage unit. The history management file 180 contains a record consisting of a toy figure ID field 180a, a toy figure type field 180b, and a use frequency field 180c, wherein a toy figure type and a use frequency are related to the toy figure ID. The toy figure type refers to a kind typified in response to the alphanumeric character of the toy figure ID, for example, “wizard” or “warrior”. The use frequency corresponds to the number of times that the slot game has been played with the toy figure 150 mounted on the toy figure mounting unit 115, wherein the number of times that the toy figure ID has been read in a to-be-described toy figure information read process is counted and stored.

In the embodiment, data stored in the record of the history management file 180 corresponds to the history information, and the record is created and updated by the main CPU 132.

Furthermore, the slot machine 101A has a touch panel 103a, a lamp drive circuit 159, a lamp 160, an LED drive circuit 161, LEDs 162, a hopper drive circuit 163, a hopper 164, a payout completion signal circuit 165, and a coin detector 166. The slot machine 101A also has an image control circuit 171, a sound control circuit 172, the LED light emission control circuit 173, and the IC chip reader/writer 115.

The touch panel 103a provided, which covers the display screen of the main display 103, detects the position of a portion thereof which the player has touched with a finger and transmits to the main CPU 132 a position signal corresponding to the detected position. The lamp drive circuit 159 sends to the lamp 160 a signal for lighting the lamp 160, thus flashing the lamp 160 during the execution of the game. An effect of the game is performed with this flash. The LED drive circuit 161 controls the flash display of the LEDs 162. The LEDs 162 display the number of credits, the number of coins won, and the like. The hopper drive circuit 163 drives the hopper 164 in accordance with the control of the main CPU 132, and the hopper 164, which operates to pay out won coins, pays out the coins to the coin receiving tray 107 from a payout opening. The coin detector 166 counts the number of coins paid out by the hopper 164 and notifies the payout completion signal circuit 165 of data consisting of the number of coins counted. The payout completion signal circuit 165 receives the data consisting of the number of coins from the coin detector 166 and sends a signal indicative of the notification of coin payout completion to the main CPU 132 when the data has reached a set number of coins.

The image control circuit 171 controls the image display of each of the main display 103 and the subsidiary display 104 to display a variety of images, such as the plurality of symbol variable display images, on the main display 103 and the subsidiary display 104.

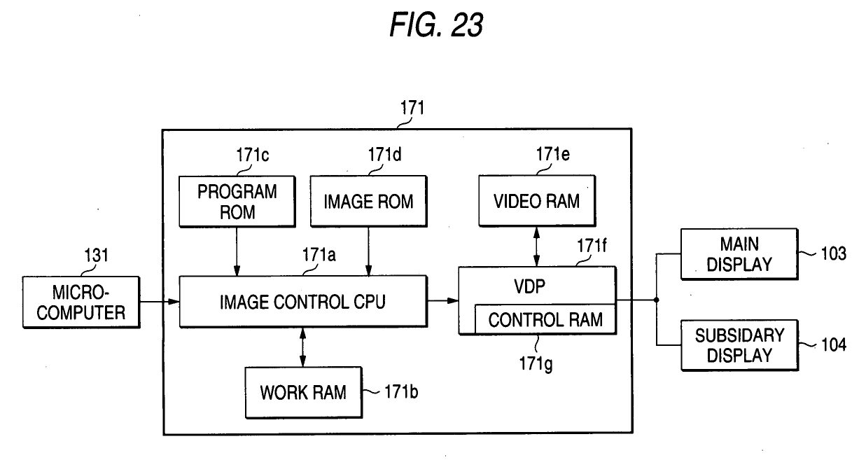

As shown in FIG. 23, this image control circuit 171 has an image control CPU 171a, a work RAM 171b, a program ROM 171c, an image ROM 171d, a video RAM 171, and a VDP (Video Display Processor) 171f. Based on parameters set by the microcomputer 131, the image control CPU 171a determines images (such as reel images and stopped symbol images to be displayed when the scrolling display is stopped) to be displayed on the main display 103 and the subsidiary display 104, in accordance with image control programs (related to the display on the main display 103 and the subsidiary display 104) preset in the program ROM 171c. The work RAM 171b is configured as temporary storage unit to be used when the image control CPU 171a executes the image control programs.

The program ROM 171c stores the image control programs, various selection tables, and the like. The image ROM 171d stores bitmap data (dot data) for forming images. In the embodiment, the dot data includes symbol image data consisting of symbols to be used in the base game and the bonus game. The video RAM 171e is configured as temporary storage unit to be used when the VDP 171f forms images. The VDP 171f, having a control RAM 171g, forms images corresponding to the display contents of the main display 103 and the subsidiary display 104, which have been determined by the image control CPU 171a, and outputs the formed images on the main display 103 and the subsidiary display 104.

The sound control circuit 172 sends to the speakers 108L and 108R a sound signal to produce a sound from the speakers 108L and 108R. From the speakers 108L and 108R is produced, for example, a sound to add excitement to the game at an appropriate time, such as before the start of the game or during the game.

The LED light emission control circuit 173 outputs a light emission signal to each light emitting element (the red light emitting element, the blue light emitting element, and the green light emitting element) in accordance with the instruction of the main CPU 132. The full color LED 116 emits various color lights, flashes, varies in color, and so on as the light emitting elements emit lights in response to the light emission signals transmitted from the LED light emission control circuit 173. Such various light emission, flashes, variations in light color, and the like are controlled (light emission control) to thereby perform the light effect of illuminating the toy figure 150, mounted on the toy figure mounting unit 111, with a variety of lights.

When the toy figure 150 is mounted in the holding hole 113a of the toy figure mounting unit 111, the IC chip reader/writer 115 reads the to-be-described toy figure ID and transmits the read toy figure ID to the main CPU 132.

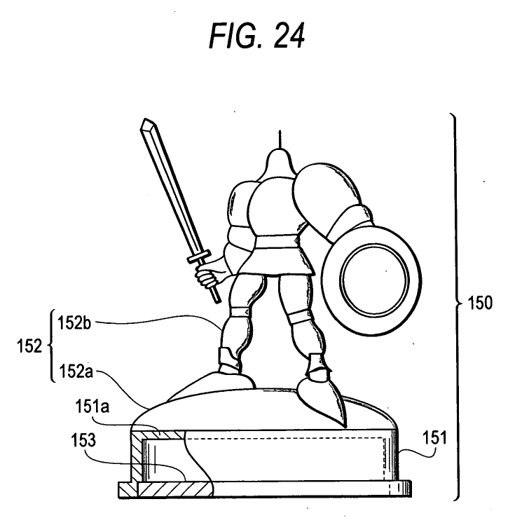

As shown in FIG. 24, the toy figure 150 has the seat 151 and a toy figure body 152, and furthermore has the IC chip 153 for storing the toy figure ID.

The seat 151, having a size corresponding to the fitting portion 114a of the toy figure mounting unit 115, is formed into a flat-bottomed cylindrical shape having a top portion 151a, and has a configuration such that the IC chip 153 is fixedly fitted in the open end portion.

The toy figure body 152 is configured to have a leg portion 152a fixed to the top portion 151a of the seat 151 and a figurine portion 152b which, formed upright on the leg portion 152a, represents a wizard, a warrior, and the like.

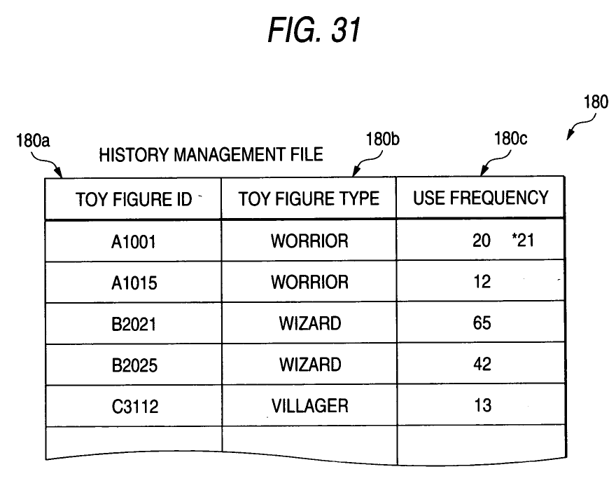

The IC chip 153 stores a toy figure ID inherent to each toy figure 150. The toy figure ID consists of an Alphabet letter and a 4-digit number. The Alphabet letter indicates the type of a toy figure corresponding to the shape of the toy figure body 152 (e.g., “A” indicates the wizard, “B” indicates the warrior, “C” indicates a villager, and so on). The 4-digit number indicates a unique identification number for distinguishing one toy figure from another (differentiating a player's toy figure from others). The toy figure 150 is thus configured such that the player can identify the type of a character by the shape of the toy figure body 152, and such that the slot machine 101A can identify each toy figure and the toy figure type classifying each toy figure. The toy figure 150 of the embodiment is the “wizard”, and the toy figure ID thereof is “A1001” (see FIG. 31). The toy figure 150 corresponds to the reading object, and the toy figure ID corresponds to the identification information of the invention.

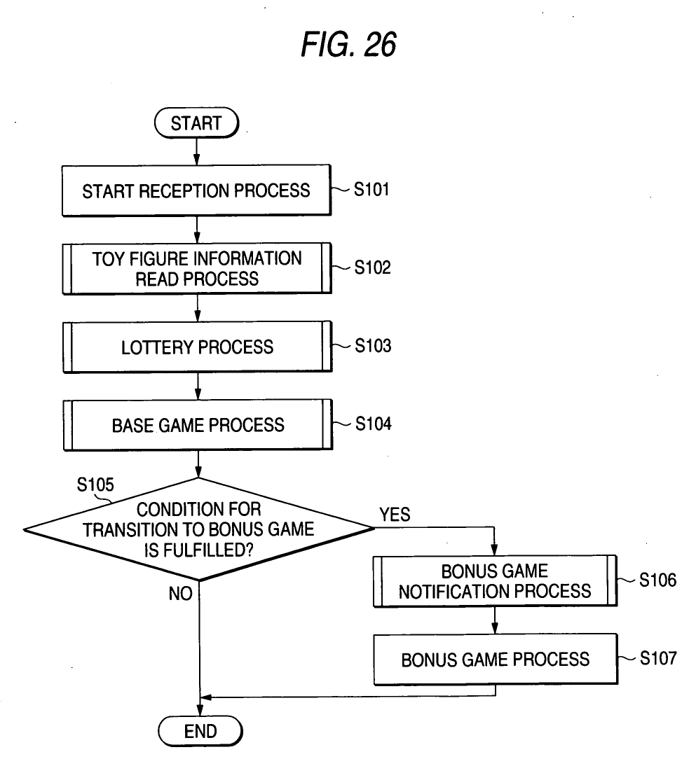

The operation of the slot machine 101A having the aforementioned configuration will now be described with reference to flowcharts shown in FIGS. 26 to 30. In the slot machine 101A, as shown in FIG. 26, first, the base game is executed, and subsequently the bonus game is executed under fixed conditions. Before the execution of the bonus game, the player is notified of a transition to the bonus game by the toy figure 150 being illuminated with a variety of lights.

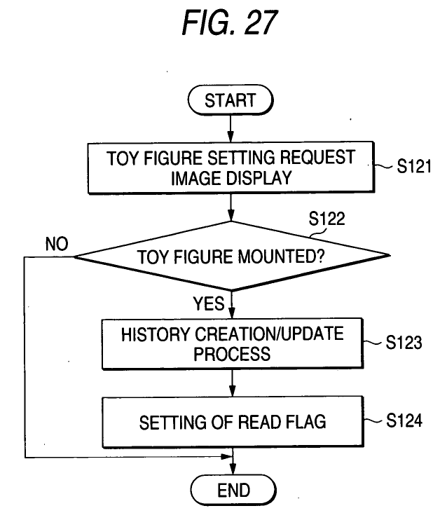

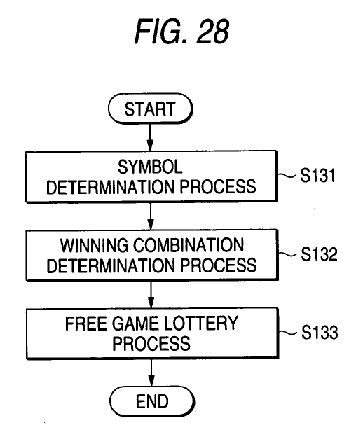

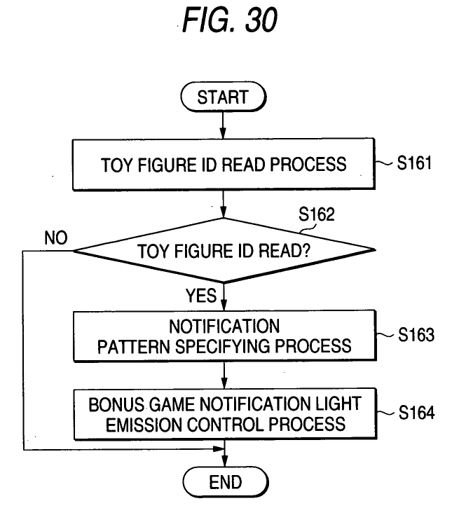

FIG. 26 is a flowchart showing an operation of a main process from the start to the end of the game on the slot machine 101A, FIG. 27 is a flowchart showing an operation of a toy figure information read process, FIG. 28 is a flowchart showing an operation of a lottery process, FIG. 29 is a flowchart showing an operation of a base game process, FIG. 30 is a flowchart showing an operation of a bonus game notification process. In FIGS. 26 to 30, the term step is abbreviated as “S”.

In the slot machine 101A, the main CPU 132, operating as the game progress control unit of the invention, controls the progress of the game. In the slot machine 101A, as shown in FIG. 26, when the main process is started, a start reception process is performed in step 101 to start the game, the toy figure information read process is performed in the subsequent step 102, and the lottery process is then performed in the subsequent step 103. In the subsequent step 104, the base game process is performed with the gaming mode in the normal gaming mode, and the process then proceeds to step 105. In step 105, in response to the result of the lottery process in step 103, the main CPU 132 determines whether the condition for making a transition to the bonus game (transition condition) is fulfilled or not. If the transition condition is not fulfilled here, the main process is terminated. However, if the transition condition is fulfilled, the main CPU 132 allows the gaming mode to make a transition from the normal gaming mode to the special gaming mode. After the process proceeds to step 106 to perform the bonus game notification process, a bonus game process (step 107) is performed, and the main process then ends. The details of each block will be described below.

First, when the process proceeds to the start reception process of step 101, the slot machine 101A receives input to start the game from the player, in accordance with the control of the main CPU 132. Since the slot machine 101A is a coin insertion type gaming machine, in order for the player to start the game, first, the player either inserts a number of coins to be bet on one game using the coin insertion slot 106, or, if any credits are remaining, operates any of the MAX-BET button 105c, the 1-BET button 105d, and the REPEAT-BET button 105e. Subsequently, the player operates the START button 105f or the REPEAT-BET button 105e (henceforth called a “start operation”). By this operation, a start signal is sent from the START button 105f to the main CPU 132.

Next, the process proceeds to step 102 to perform a toy figure information read process. When the toy figure information read process starts, the process proceeds to step 121 shown in FIG. 27, wherein the main CPU 132 instructs the image control circuit 171 to display the following image (henceforth called a “request image” on the main display 103: the image requiring a player possessing a toy figure to mount the toy figure, or the image requiring a player possessing no toy figure to select “no toy figure”. In accordance with this request image, the player possessing the toy figure 150 can mount the toy figure 150 on the toy figure mounting unit 115, while the player possessing no toy figure can select “no toy figure” by touching the touch panel 103a. When the toy figure 150 is mounted on the toy figure mounting unit 111, the IC chip reader/writer 115 reads the toy figure ID, and the read toy figure ID is sent from the IC chip reader/writer 115 to the main CPU 132. On the other hand, when “no toy figure” is selected, a position signal issued with the selection is sent from the touch panel 103a to the main CPU 132.

In the subsequent step 122, the main CPU 132 determines whether the toy figure ID has been read or “no toy figure” has been selected. If the toy figure ID has been received from the IC chip reader/writer 115, the main CPU 132 determines that the toy figure ID has been read, and then proceeds to step 123. If the position signal issued with the selection of “no toy figure” has been received from the touch panel 103a, the main CPU 132 determines that “no toy figure” has been selected, and then terminates the toy figure information read process.

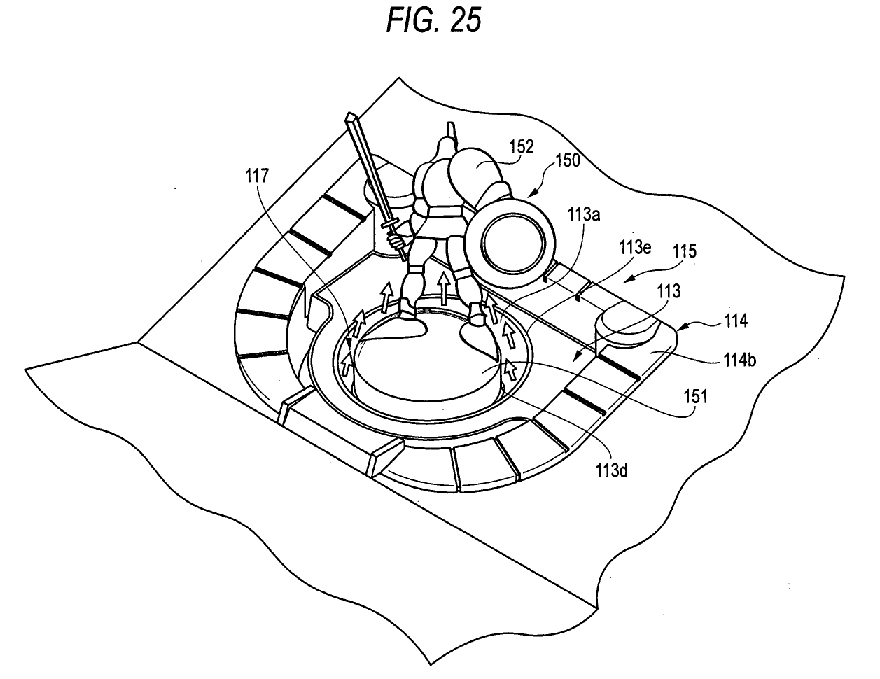

In step 123, the main CPU 132 operates as update unit to perform a history creation/update process. In the history creation/update process, the main CPU 132 sets the received toy figure ID to a search key and performs a search for an appropriate record by referring to the history management file 180 (see FIG. 31). If the appropriate record exists, the main CPU 132 performs the update process in which the use frequency is updated by adding “1” to the number value of the record in the use frequency field 180c. In the embodiment, the toy figure ID of the toy figure 150 (see FIG. 25) mounted on the toy figure mounting unit 115 is “A1001”, and the number value in the use frequency field 180c is “20”. Therefore, the main CPU 132 performs the use frequency update process to the record corresponding to the toy figure ID “A1001” and thus changes the number value in the use frequency field 180c to “21”](see the asterisked number in FIG. 31). If there is no record corresponding to the toy figure ID inputted to the main CPU 132, the main CPU 132, regarding the toy figure of this toy figure ID as being used for the first time, creates a new record having “1” as the number value in the use frequency field 180c.

When the process proceeds to the subsequent step 124, the main CPU 132 writes predetermined information (e.g., “9”) to a read flag, and then terminates the toy figure information read process. This read flag indicates whether the toy figure ID has been read or not, i.e., indicates that the toy figure ID has been read by writing “9”.

Next, the process proceeds to step 103 shown in FIG. 26 to perform the lottery process. When the lottery process is started, the process proceeds to step 131 shown in FIG. 28, wherein a symbol determination process is performed by the main CPU 132. In the symbol determination process, the main CPU 132 operates as the symbol determination unit to determine symbols to be displayed stopped by stopping variable display in the variable display windows 103A to 103I (which symbols are henceforth called “stop symbols”). In the slot machine 101A, during this lottery process, the main CPU 132 instructs the image control circuit 171 to display on the subsidiary display 104 an image for providing the game with an effect.

In this lottery process, having detected a player's start operation based on a start signal from the START button 105f, in response to the detection (i.e., in the wake of the game starting), the main CPU 132 instructs the random number generator 135 to generate a set range of random numbers. In addition, the main CPU 132 instructs the sampling circuit 136 to extract any random number from among the random numbers generated by the random number generator 135. When the random number is extracted, the main CPU 132 sets the random number to a search key and acquires an appropriate symbol code number by referring to a not-shown symbol determination table (in which symbol code numbers and random numbers are stored related to each other) which is stored in the ROM 134.

Next, the main CPU 132 sets the acquired code number to a search key and performs a search for stopped symbols to be displayed stopped in the respective variable display windows 103A to 103I, by referring to a not-shown stop table (in which symbol code numbers and stop symbols are stored related to each other) which is stored in the ROM 134.

Then, in the slot machine 101A, the extraction of a random number and the search of both the symbol determination table and the stop table are performed for each of the variable display windows 103A to 103I, a total of nine times. That is, each table search is performed a number of times corresponding to the number of variable display windows, thus determining stop symbols for the respective variable display windows 103A to 103I.

Having determined the stop symbols for the respective variable display windows 103A to 103I, the main CPU 132 determines whether a winning combination is obtained or not, by referring to a winning combination determination table stored in the ROM 134. In the winning combination determination table, winning symbol patterns and non-winning symbol patterns are distinguishably registered and related to the combinations of code numbers (henceforth called “code number patterns”). After a code number pattern corresponding to the stop symbols is determined in step 131, the main CPU 132 operates as winning combination determination unit to set the code number pattern corresponding to the stop symbols to a search key. The main CPU 132 then refers to the winning combination determination table, and determines from the reference result whether the variable display game has been won or not.

Subsequently, the main CPU 132 performs a winning state determination process for determining a winning state (which is also called a “winning combination”) by referring to a state table. The state table, which is used to determine the states (winning states) in which winning combinations are obtained, registers awards corresponding to the winning states.

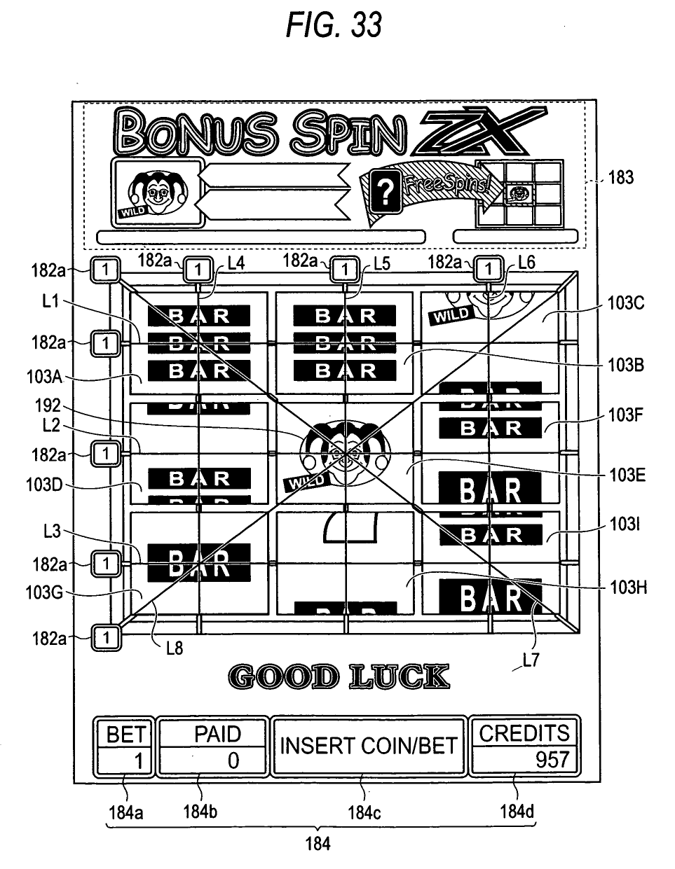

Subsequent to step 132, the process proceeds to step 133 to perform a bonus game lottery process. In this bonus game lottery process, when the stop symbol of the variable display window 103E (see FIG. 33) is a Wild Joker 192, it is determined in a to-be-described step 105 that the transition condition for making a transition to the bonus game has been fulfilled, thus causing the gaming mode to make a transition to the special gaming mode. Therefore, a lottery for determining the content of a bonus game, to be executed after a transition is made to the special gaming mode, is performed in the bonus game lottery process. Specifically, the main CPU 132 performs a predetermined table search and determines the number of times that the bonus game is to be executed after a transition is made to the special gaming mode. Furthermore, the main CPU 132 determines stop symbols in each bonus game by referring to the aforementioned stop table, determines whether or not a winning combination is obtained in each bonus game by referring to the winning combination determination table, and determines a winning state in each bonus game. Thereafter, the lottery process is terminated.

The Wild Joker 192, which, when displayed, offers to the player a greater advantage than any other symbol, is configured by combining an image showing a joker's face and a character string “WILD” as shown in FIG. 33.

After the lottery process is terminated, the process proceeds to step 104 shown in FIG. 26 to perform a base game process. When the base game process is started, the process proceeds to step 141 shown in FIG. 29 to perform a scroll process, wherein an image such as shown in FIG. 33 is displayed on the main display 103. At this point, the aforementioned nine variable display windows 103A to 103I are displayed on the main display 103. In addition, a title display portion 183 including a character string “BONUS SPIN” and gaming instructions is displayed above the variable display windows 103A to 103I. Displayed below the variable display windows 103A to 103I is a meter display portion 84 having a BET display portion 184a for displaying a number of bets, a PAID display portion 184b for displaying a number of coins paid, an INSERT COIN/BET display portion 184c, and a CREDIT display portion 184d for displaying the number of credits. Eight BET display portions 182a for displaying a number of bets placed on each pay line are arranged surrounding the periphery of the variable display windows 103A to 103I.

After the game starts, the scroll process for variably displaying symbols in the variable display windows 103A to 103I on the main display 103 is performed in accordance with the instruction of the main CPU 132.

In the subsequent step 142, the main CPU 132 operates as the light emission control unit of the invention to perform an LED light emission control process. In the LED light emission control process, the main CPU 132 determines whether the toy figure ID has been read or not. If “9” has been written to the read flag, the main CPU 132 determines that the toy figure ID has been read and thus instructs the LED light emission control circuit 173 to cause the full color LED 116 to emit light, for example, purple light. Then, as shown by the arrows in FIG. 25, the purple light is emitted from the peripheral wall surface 113a of the holding member 113, which forms the holding hole 117, to illuminate the toy figure 150, thus performing a light effect which resembles the toy figure 150 being luminous while reflecting the light. The toy figure 150 of the embodiment is configured to be mounted on the toy figure mounting unit 115, but is not a component provided in the slot machine 101A. That is, the slot machine 101A is configured capable of performing the notification of the normal gaming mode using a component not part of the machine itself. In addition, the toy figure 150 is three-dimensional, which is therefore likely to appeal to the eye of the player unlike a two-dimensional image display. Moreover, the slot machine 101A adopts the effect of illuminating the toy figure 150, which therefore looks innovative to the eye of the player. Thus, the light emission pattern of light colors, flashes, and the like can be varied, which provides the notification with diversity.

Conversely, if “9” has not been written to the read flag, the process proceeds to step 143 without causing the full color LED 116 to emit light.

When the process proceeds to step 143, a stop control process is performed, wherein stop symbols corresponding to the result of the lottery process in step 2 are displayed on the respective variable display windows 103A to 103I while the speed of scrolling is gradually being reduced.

In the subsequent step 144, the main CPU 132 operates as a light emission control unit to perform an LED extinction control process. In the LED extinction control process, the main CPU 132 determines whether or not “9” has been written to the read flag. If “9” has been written to the read flag, the main CPU 132 clears the read flag and proceeds to step 145.

Conversely, if “9” has not been written to the read flag, the full color LED 116 is in its extinguished state, and the process proceeds directly to step 145.

In the next step 145, when a winning combination has been obtained, a number of coins equivalent to the winning state are paid out, and the base game process is then brought to an end.

In the base game process, the full color LED 116 is thus controlled as to its light emission (turned on to emit a predetermined color light and turned off) in response to the process of the base game in the normal gaming mode, when “9” has been written to the read flag, i.e., when the toy figure ID has been read.

When the base game process is terminated, as shown in FIG. 26, the process proceeds to step 105, wherein the main CPU 132 determines-whether the transition condition for allowing the gaming mode to making a transition to the special gaming mode is fulfilled or not, based on the result of the symbol determination process in step 103. If the transition condition is fulfilled, i.e., “if the stop symbol in the variable display window 3E is the Wild Joker 192,” the main CPU 132 operates as the transition unit to allow the gaming mode to make a transition to the special gaming mode, and then proceeds to step 106 to perform a bonus game notification process before the bonus game process (step 107).

In the bonus game notification process, the process proceeds to step 161 in FIG. 30, wherein the IC chip reader/writer 115 reads the toy figure ID again. The read toy figure ID is transmitted to the main CPU 132, and the process then proceeds to step 162.

In the subsequent step 162, the main CPU 132 determines whether the toy figure ID has been read or not. If the toy figure ID has been received, the main CPU 132 determines that the toy figure ID has been read and then proceeds to step 163. If the toy figure ID has not been received, the main CPU 132 determines that the toy figure ID has not been read and then terminates the bonus game notification process. By thus reading the toy figure ID again, the full color LED 116 can be prevented from emitting light in the case in which no toy figure 150 is mounted.

When the process proceeds to step 163, a notification pattern specifying process is performed. In the notification pattern specifying process, the main CPU 132 sets the received toy figure ID to a search key by referring to the history management file 180 (see FIG. 31) in the data storage unit 141, and then acquires the use frequency of an appropriate toy figure 150. Here, the use frequency acquired refers to the use frequency obtained after the main CPU 132 operates as the update unit to perform the update process in the aforementioned step 123. Thereafter, the main CPU 132 sets the acquired use frequency to a search key, and then determines a notification pattern corresponding to the process of the game (in the embodiment, before the bonus game is executed) by referring to the notification pattern table 181 (see FIG. 32) stored in the ROM 134. The notification pattern table 181 is prepared for each type of toy figure (such as the “wizard” or the “warrior”) in response to the progress of the game. As shown in FIG. 32, the notification pattern table 181 has a use frequency range field 181a and a notification pattern field 181b in which notification patterns (movement patterns of the movable pedestal 115a) are stored related to use frequency ranges, differentiated from one another in the use frequency range field 181a.

In the use frequency range field 181a the use frequencies are registered and differentiated from one another for each fixed range (use frequency range), while in the notification pattern field 181b are registered five different kinds (01, 02, 03, 04, and 05) of notification patterns related to the use frequency ranges. For example, the notification patterns can be configured such that light emitted from the full color LED 116 is varied in hue, saturation, and brightness, the light is varied in intensity (luminosity), the time of light emission of the full color LED 116 is varied, or a light emission mode is varied, such as by flashing the light or alternately lighting a plurality of color lights. Furthermore, the light intensity is gradually increased from the notification pattern “01” to the notification pattern “05”, the time of light emission is lengthened, or the light emission mode is made more complicated (e.g., single color light emission at “01”, flashes at “02”, and alternate lighting of two color lights). Especially, with such a configuration, the light effect performed by the full color LED 116 is increased as the use frequency increases, which can encourage the player to use the same toy figure repeatedly. Suitably, this makes it possible to increase a player's attachment to the toy figure and thus to motivate the player to collect toy figures.

The notification pattern is thus varied based on the use frequency, thereby varying the effect for notifying the player of the bonus game accordingly, which can increase the entertainment of the game.

When the process proceeds to the subsequent step 164, the main CPU 132 operates as the light emission control unit to perform a bonus game notification light emission control process, and thus terminates the bonus game notification process. In the bonus game notification light emission control process, based on the notification pattern determined in step 163, the main CPU 132 instructs the LED light emission control circuit 173 to control the light emission for sequentially emitting or flashing the predetermined color light and furthermore varying the plurality of color lights, thus illuminating the toy figure 150. Such lighting of the toy figure 150 notifies the player of the transition to the bonus game.

In the bonus game notification light emission control process, based on the notification pattern determined in step 163, the main CPU 132 thus controls the light emission of the full color LED 116 in lighting the toy figure 150, thereby notifying the player of the transition to the bonus game. That is, the slot machine 101A is configured to be capable of using a component not part of the machine itself to perform the notification of the game progress which is at the stage before the execution of the bonus game. In addition, similar to the aforementioned notification of the game progress in the base game, the toy figure 150 is formed three-dimensionally, which is therefore likely to appeal to the eye of the player, and the notification is made by lighting the toy figure 150, which therefore looks innovative to the eye of the player. Furthermore, the pattern of lighting the toy figure 150 can be varied, thus providing the notification with diversity.

When the bonus game notification process is terminated, the process proceeds to step 107 shown in FIG. 26 to perform the bonus game process. In the bonus game process, the main CPU 132 performs a free spin variable display game which requires no input from the player to start and stop the game, in accordance with the result of a bonus game lottery in step 133 (see FIG. 28), and thereafter ends the game.

In the embodiment, the light emission of the full color LED 116 is thus controlled in response to the progress of the slot game which is at the stage before the execution of the bonus game (ready to execute the bonus game), based on the use frequency corresponding to the toy figure ID.

As described above, in the slot machine 101A of the embodiment, the notification is made of the game progress (such as during the symbol scroll process or before the execution of the bonus game) by the light effect of lighting the toy figure 150 which is a component not part of the machine itself. Therefore, the notification effect can easily be diversified by varying the light emission pattern of light colors, flashes, and the like. Additionally, in the embodiment, the light emission pattern is varied based on the use frequency corresponding to the toy figure ID, which therefore makes it unlikely for the player to become tired of the notification effect. Furthermore, the light emission pattern is configured to become more complicated as the use frequency increases, thereby enabling a differing effect configured such that the player will be able to enjoy a complicated light emission pattern by continuously using the same toy figure. This makes it possible to encourage the player to use the same toy figure, which also yields the advantage of leading the player to have an attachment to the toy figure and thus motivating the player to collect toy figures.

### Sixth Embodiment

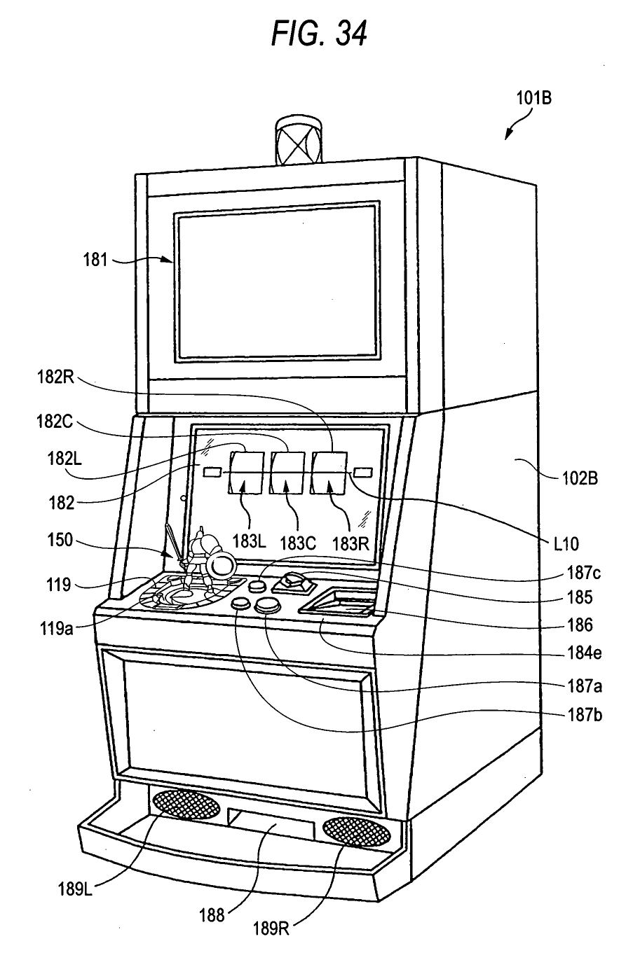

A slot machine 101B according to a sixth embodiment will subsequently be described with reference to FIG. 34. FIG. 34 is a perspective view showing the overall configuration of the slot machine 101B. The slot machine 101B, having variable display unit for variably displaying a plurality of symbols, is configured capable of using the variable display unit to perform a variable display game (slot game) which employs the variable display of the plurality of symbols. Similar to the slot machine 101A, the slot machine 101B has a normal gaming mode in which a base game can be performed and also a special gaming mode in which a bonus game which is started under predetermined conditions subsequent to the base game can be performed, and is thus configured to be capable of performing the variable display game in the special gaming mode as well as in the base game mode. And, when a toy figure ID has been read, the light emission of a to-be-described toy figure mounting unit 119 (full color LED) is controlled in corresponding to the progress of the game, based on history information (use frequency) corresponding to the toy figure ID, thus notifying the player of a game process, such as during the base game or before the bonus game. The configuration of the slot machine 101B will be described in detail below.

The slot machine 101B has, on the front side of a cabinet 102B, an image display 181 and a symbol display 182 in the order named from the top. The symbol display 182 is vertically located in an approximately central portion of the cabinet 102B. Inside the cabinet 102B, three mechanical reels 183L, 183C, and 183R are rotatably arranged in a horizontal row relative to three display windows 182L, 182C, and 182R formed in the symbol display 182.

The reels 183L, 183C, and 183R are rendered visible from the outside through the display windows 182L, 182C, and 182R. A-symbol column (not shown) having plural kinds of symbols is displayed on the periphery of each of the reels 183L, 183C, and 183R. The reels 183L, 183C, and 183R, each configuring the variable display unit which is rotatable so as to variably display its symbols, each rotate at a constant speed (e.g., 80 revolutions per minute).

Relative to the reels 183L, 183C, and 183R, as shown in FIG. 34, one pay line L10 extending horizontally is provided on the display windows 182L, 182C, and 182R.

An approximately horizontal operation platform 184e is provided below the symbol display 182. The operation platform 184e is provided with the toy figure mounting unit 119, a coin insertion slot 185, a bill insertion slot 186, a SPIN switch 187a, a 1-BET switch 187b, and a MAX-BET switch 187c.

The toy figure mounting unit 119, which serves as a light emitting holding unit, has a holder 119a, a full color LED (not shown), and the like, and an IC chip reader/writer is incorporated into the toy figure mounting unit 119. Similar to the toy figure mounting unit 111 of the slot machine 101A, the toy figure mounting unit 119 holds a toy figure 150 so that the toy figure ID can be read by the IC chip reader/writer, and emits light toward the held toy figure 150.

The coin insertion slot 185 and the bill insertion slot 186 are provided for the player to insert coins and bills, respectively, to be bet in the game. The SPIN switch 187a is provided to start the symbol variable display by rotation of the reels 183L, 183C, and 183R in the display windows 182L, 182C, and 182R. The 1-BET switch 187b is provided for placing the bet of one coin in a single operation. The MAX-BET switch 187c is provided for placing the bet of the maximum number of coins that can be bet on one game in a single operation. In addition, a coin payout opening 188 is provided at the bottom of the cabinet 102B, and speakers 89L and 89R are provided on the left and right sides of the payout opening 188.

Similar to the slot machine 101A, the slot machine 101B includes: a microcomputer which, having a main CPU, a RAM, a ROM, and the like, controls the operation of the entire slot machine 101B; a data storage unit for storing a history management file; the IC chip reader/writer for reading the toy figure ID from the toy figure 150 mounted on the toy figure mounting unit 119; a light emission control circuit for causing the full color LED to emit light, and the like. The main CPU operates as the game progress control unit of the invention to control the progress of the variable display game and the light emission control unit of the invention to control the light emission of the full color LED. In addition, the main CPU operates as the update unit for creating and updating the history management file.

The slot machine 101B of the embodiment yields the same advantage as the aforementioned slot machine 101A, thus making it possible to easily diversify the notification effect.

### Seventh Embodiment

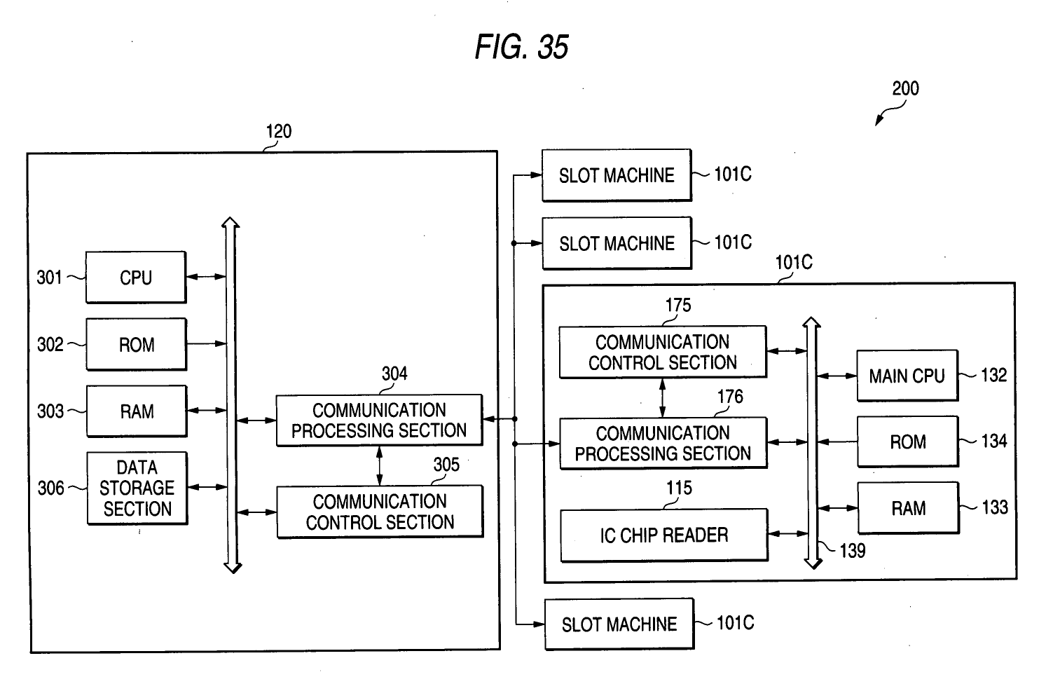

A description will subsequently be given of a seventh embodiment of a gaming system of the invention. FIG. 35 is a block diagram showing the outlined configuration of a gaming system 200 according to the seventh embodiment. The gaming system 200 having a server 120 installed in a game arcade and a plurality (in the embodiment, four) of slot machines 101C communicably connected to the server 120. In the game arcade, the server 120 and the slot machines 101C, having a dedicated connection to one another, form an in-house LAN.

As in the aforementioned slot machine 101A of the fifth embodiment, each of the slot machines 101C, having a plurality of variable display windows for displaying a plurality of symbol variable display images, is configured capable of performing a variable display game (also called slot game) which uses the variable display images displayed in the respective variable display windows.

As in the aforementioned slot machine 101B of the sixth embodiment, the slot machines 101C may be each configured to have variable display unit for variably displaying a plurality of symbols, and configured capable of using the variable display unit to perform a variable display game which employs the variable display of the plurality of symbols. In this case, the gaming machine includes communication processing unit for transmitting/receiving data from a game server, and a main CPU operates as the game progress control unit for controlling the variable display game which uses the plurality of symbols variably displayed.

The server 120 has a CPU 301, a ROM 302, a RAM 303, a communication processing section 304, a communication control section 305, and a data storage unit 306 which stores a history management file. The CPU 301 serves as an update unit, and the communication processing section 304 and the communication control section 305 serve as a communication processing unit of the game server.

The CPU 301 operates while reading/writing data to the RAM 303 in accordance with a program stored in the ROM 302, while the communication control section 305 activates the communication processing section 304 in accordance with the instruction of the CPU 301, thus transmitting/receiving data from the slot machines 101C. Furthermore, the CPU 301 creates is and updates the record of the history management file, based on a toy figure ID transmitted from each of the slot machines 101C. The history management file, having the same configuration as that described in the aforementioned slot machine 101A, has a record consisting of a toy figure ID field, a toy figure type field, and a use frequency field. Data recorded in this record corresponds to the history information of the invention.

Each of the slot machines 101C, although having a communication processing section 176 and a communication control section 175, is different from the aforementioned slot machine 101A in that it has no data storage unit. The communication processing section 176 and the communication control section 175 are connected to the main CPU 132 via an I/O port 139, and the communication control section 175 activates the communication processing section 176 in accordance with the instruction of the CPU 301 and thus transmits/receives data from the server 120. In addition, similar to the aforementioned slot machine 101A, the slot machines 101C also each include a toy figure mounting unit, an IC chip reader/writer 115, and the like. The communication processing section 176 and the communication control section 175 serve as a communication processing unit of the gaming machine, and the main CPU 132 operates as the game progress control unit and a light emission control unit. Furthermore, the not-shown toy figure mounting unit corresponds to the light emitting holding unit, and the IC chip reader/writer 115 corresponds to the read out unit. Since the other components of each of the slot machines 101C are covered by the components common with the aforementioned slot machine 101A, like components are identified by like reference numerals, thus the description is omitted.

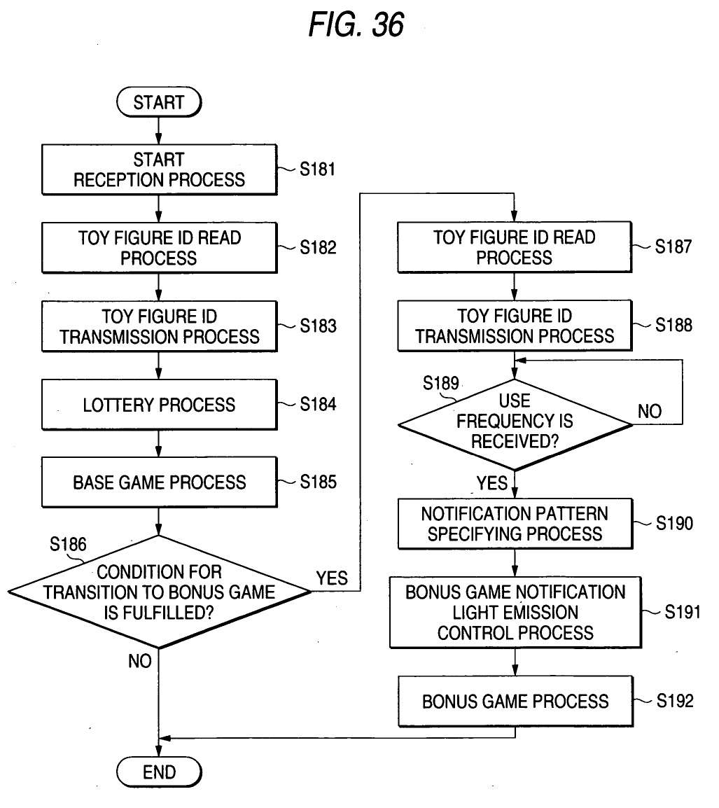

The operation of the gaming system 200 having the aforementioned configuration will be described with reference to a flowchart shown in FIG. 36, focusing on the operation of each of the slot machines 101C. FIG. 36 is a flowchart showing the operation of each of the slot machines 101C in a main process from the start to the end of the game, wherein one of the plurality of slot machines 101C installed in the game arcade is described as an example. In addition, when the following description falls under the same operation as in each process described in the aforementioned slot machine 101A, a detailed description will be omitted by using similar process names. Furthermore, in FIG. 36, the term step is abbreviated as “S”.

In the gaming system 200, the main CPU 132 of the slot machine 1D operates as the game progress control unit of the invention to control the progress of the game. As shown in FIG. 36, when the main process is started, at the start of the game, in step 181, a start reception process is performed. In the subsequent step 182, a toy figure ID read process is performed, and the process proceeds to the subsequent step 183. In the toy figure ID read process, the IC chip reader/writer 115 reads the toy figure ID of a toy figure 150 mounted on the toy figure mounting unit 111, and sends the read toy figure ID to the main CPU 132.

In the subsequent step 183, the main CPU 132 instructs the communication control section 175 to transmit the received toy figure ID from the communication processing section 176 to the game server 120. In the game server 120, upon receiving the toy figure ID, the CPU 301 operates as the update unit of the invention to perform a history creation/update process for creating or updating the record of the history management file stored in the data storage unit 306. In the history creation/update process, the CPU 301 sets the transmitted toy figure ID to a search key and performs a search for an appropriate record by referring to the history management file. If the appropriate record is present, the CPU 301 performs a use frequency update process in which “1” is added to the number value of this record in the use frequency field. If the appropriate record is absent, the main CPU 132, regarding the toy figure of this toy figure ID as being used for the first time, creates a new record having “1” as its number value in the use frequency field.

When the process proceeds to the subsequent step 184, a lottery process is performed in the slot machine 1D. When the process proceeds to the subsequent step 185, a base game process is performed, and the process then proceeds to step 186.

When the process proceeds to step 186, it is determined whether the transition condition for making a transition to the bonus game is fulfilled or not. If the transition condition is fulfilled, the process proceeds to step 187, while, if the transition condition is not fulfilled, the main process is terminated.

When the process proceeds to step 187, the IC chip reader/writer of the slot machine 101C reads the toy figure ID again, and the read toy figure ID is sent to the main CPU 132. If the toy figure ID has been received, it is determined that the toy figure ID has been read, and the process then proceeds to step 188.

When the process proceeds to step 188, a toy figure ID transmission process is performed, and the main CPU 132 instructs the communication control section 175 to transmit the toy figure ID from the communication processing section 176 to the game server 120. Upon receiving the toy figure ID, the game server 120 sets this toy figure ID to a search key and makes a search for an appropriate record by referring to the history management file stored in the data storage unit 306, thus acquiring a use frequency. This use frequency refers to the use frequency having been subjected to the update process by the CPU 301 operating as the aforementioned update unit. Thereafter, the CPU 301 instructs the communication control section 305 to transmit the acquired use frequency, as history information, from the communication processing section 304 to the slot machine 10C.

In the slot machine 10C, in step 189, data indicative of a use frequency (frequency data) is awaited until received, and when received, the frequency data is sent from the communication processing section 176 to the main CPU 132. The process thereafter proceeds to the subsequent step 190 to perform a notification pattern specifying process. In the notification pattern specifying process, the main CPU 132 sets the use frequency based on the frequency data to a search key, and acquires an appropriate notification pattern by referring to a notification pattern table stored in the ROM 134.

When the process proceeds to the subsequent step 191, a bonus game notification light emission control process is performed, and the main CPU 132 operates as the light emission control unit to control the light emission of a full color LED 116 in response to the acquired notification pattern. After the subsequent bonus game process (step 192), the main process is terminated.

According to the gaming system of the seventh embodiment, the player is notified of the game process (such as during a symbol scroll process in the base game or before the execution of the bonus game) using the light effect for lighting the toy figure 150 which is a component not part of slot machine 101C. The light emission pattern, of light colors, flashes and the like, is varied, thereby making it possible to easily diversify the notification effect.

The gaming machine and gaming system of the invention have so far been described based on the fifth to seventh embodiments. However, the present invention is not limited to the aforementioned embodiments. For example, in the aforementioned embodiments, the game, which is performed by controlling the progress of the game related to the variable display game (slot game), has been described as an example, but the following games may be adopted: an image game such as a card game in which card images are displayed and a mahjong game in which mahjong tiles are displayed; an image game in which character images move in response to a player's input; and the like.

Additionally, the light source of the invention is not limited to the full color LED 116, but may be a single color LED, a tungsten halogen lamp, or the like.

In addition, the light emission of the full color LED 116 may be configured to be controlled in response to the progress of the image game or the variable display game, based on the toy figure type (such as “wizard” or “warrior”) classified by the toy figure ID. For example, if the toy figure type is “warrior”, red light is emitted, or if the toy figure type is “wizard”, blue light is emitted.

Furthermore, the history information is not limited only to the use frequency. For example, the following configuration may be adopted. That is, at the start and end of the main process of the game, the toy figure ID is read, and the time of day when the toy figure ID has been read is acquired, thus calculating the time period of the toy figure being used in one round of the game. Besides, the time periods, in which the toy figure has been used in a plurality of rounds of the game, are accumulated and stored in the history management file as cumulative use time. Thus, based on the cumulative use time, the light emission of the full color LED 116 is controlled in response to the progress of the image game or the variable display game.

Additionally, in the aforementioned embodiments, the management and update process of the history information are performed in the gaming machine and the game server. Alternatively, the configuration may be such that the history information is stored in the IC chip 153 of the toy figure 150, and thus such that the process of rewriting and updating the history information is performed by the IC chip reader/writer 115 when appropriate.

Furthermore, in the aforementioned embodiments, the light emission of the full color LED 116 is controlled using a predetermined notification pattern in order to make the notification of the transition to the bonus game. Alternatively, it is also possible, when no transition is made to the bonus game, to perform a false notification consisting of controlling the light emission using a different notification pattern from the aforementioned notification pattern, and thus to perform an effect such that a player's interest in the game is increased by intentionally betraying the player's expectations.

Still furthermore, the aspect in which the identification information and the history information are stored in the reading object is not limited to a noncontact IC chip capable of reading data, but may be contact-type data storage unit. The following configuration may also be adopted. That is, instead of providing data storage unit such as a memory, an information display section having an information storage function is provided on the reading object in such a manner that a seal having a barcode or a two-dimensional code printed thereon is attached to the reading object, or that a barcode or a two-dimensional code are printed or stamped directly on the reading object. The reading object thus stores the identification information and the history information. The two-dimensional code is also called a two-dimensional barcode, which includes, for example, “QR Code” (the trademark of Denso Wave Incorporated). This two-dimensional code contains a large amount of information obtained by encoding data having a capacity tens of times to hundreds of times that of the barcode. To provide the information display section in such a manner, the aforementioned IC chip reader/writer is replaced with a barcode reader or the like as the read out unit.

In the above description, the embodiments are described of slot machines that provides a slot game to the player. However, the present invention may be applied to any types of gaming machines that provide games other than the slot game. One example of such gaming machines to which the present invention may be applied is a gaming machine that provides a game of video poker to the player.

In the above description, there are described in detail of seven independent embodiments of the first to the seventh embodiments to which the present invention is applied. However, one skilled in the art may arbitrary combine the subject matters included in the two embodiments to thereby provide a gaming machine and a gaming system having the advantages described above with respect to the seven embodiments.

The foregoing description of the embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable those skilled in the art to utilize the invention in various embodiments and with various modifications as are suited to the particular use contemplated. It is intended that the scope of the invention be defined by the claims appended hereto, and their equivalents.

What is claimed is:

1. A gaming machine comprising:
a game processing unit that performs game processing to provide a game to a player;
a display unit that displays a game image related to the game provided by the game processing unit;
a movable holding unit that holds a reading object mounted thereon, the reading object being provided with a storage medium in which an identification information that identifies the reading object is stored;
an information reading unit that reads the identification information from the reading object mounted on the movable holding unit;
an actuating unit that actuates the movable holding unit; and
a control unit that controls the actuating unit to move the reading object being mounted on the movable holding unit in response to the progress of the game provided by the game processing unit, when the identification information is read by the information reading unit.

2. The gaming machine according to claim 1, wherein the movable holding unit includes:
a movable pedestal that holds the reading object mounted thereon, the movable pedestal being movably provided;
a frame that surrounds the movable pedestal, and wherein the actuating unit includes:
a power generator that generates power to move the movable pedestal; and
a power transmission mechanism that transmits the power generated by the power generator to the movable pedestal.

3. The gaming machine according to claim 1, wherein the control unit controls the actuating unit to move the reading object being mounted on the movable holding unit in accordance with a history information that indicates a history of usage of the reading object that is identified by the identification information read by the information reading unit.

4. The gaming machine according to claim 1, wherein the display unit variably displays a plurality of symbols arranged on a plurality of reels.

5. The gaming machine according to claim 4, wherein the display unit is provided with a plurality of mechanical reels as the plurality of reels.

6. The gaming machine according to claim 1, wherein the information reading unit reads the identification information from the reading object without contacting the reading object.

7. The gaming machine according to claim 1, wherein the reading object is a three-dimensional toy figure.

8. A gaming system comprising:
a gaming machine; and
a server that is connected to the gaming machine through a computer network,
wherein the gaming machine comprises:
a game processing unit that performs game processing to provide a game to a player;
a display unit that displays a game image related to the game provided by the game processing unit;
a movable holding unit that holds a reading object mounted thereon, the reading object being provided with a storage medium in which an identification information that identifies the reading object is stored;
an information reading unit that reads the identification information from the reading object mounted on the movable holding unit;
an actuating unit that actuates the movable holding unit;
a control unit that controls the actuating unit to move the reading object being mounted on the movable holding unit; and
a first communication unit that transmits the identification information read by the information reading unit to the server,
wherein the server comprises a second communication unit that transmits a history information that indicates a history of usage of the reading object that is identified by the identification information transmitted from the first communication unit of the gaming machine, and
wherein the control unit controls the actuating unit to move the reading object being mounted on the movable holding unit in accordance with the history information transmitted from the second communication unit of the server.

9. The gaming system according to claim 8, wherein the server further comprises an update unit that updates the history information based on the identification information transmitted the first communication unit of the gaming machine, and
wherein the second communication unit transmits the history information being updated by the update unit.

10. A gaming machine comprising:
a game processing unit that performs game processing to provide a game to a player;
a display unit that displays a game image related to the game provided by the game processing unit;
a light emitting holding unit that holds a reading object mounted thereon and emits light to illuminate the reading object, the reading object being provided with a storage medium in which an identification information that identifies the reading object is stored;
an information reading unit that reads the identification information from the reading object mounted on the movable holding unit; and
a control unit that controls the light emission unit to illuminate the reading object in response to the progress of the game provided by the game processing unit, when the identification information is read by the information reading unit.

11. The gaming machine according to claim 10, wherein the light emitting holding unit includes:
a light source that emits the light; and
a holder that is provided with a holding hole for inserting the reading object and a light transmission portion disposed between a peripheral wall surface of the holding hole and the light source, and
wherein the control unit controls the light source to illuminate the reading object.

12. The gaming machine according to claim 10, wherein the control unit controls the light emission unit in accordance with a history information that indicates a history of usage of the reading object that is identified by the identification information read by the information reading unit.

13. The gaming machine according to claim 10, wherein the display unit variably displays a plurality of symbols arranged on a plurality of reels.

14. The gaming machine according to claim 13, wherein the display unit is provided with a plurality of mechanical reels as the plurality of reels.

15. The gaming machine according to claim 10, wherein the information reading unit reads the identification information from the reading object without contacting the reading object.

16. The gaming machine according to claim 10, wherein the reading object is a three-dimensional toy figure.

17. A gaming system comprising:
a gaming machine; and
a server that is connected to the gaming machine through a computer network,
wherein the gaming machine comprises:
a game processing unit that performs game processing to provide a game to a player;
a display unit that displays a game image related to the game provided by the game processing unit;
a light emitting holding unit that holds a reading object mounted thereon and emits light to illuminate the reading object, the reading object being provided with a storage medium in which an identification information that identifies the reading object is stored;
an information reading unit that reads the identification information from the reading object mounted on the movable holding unit;
a control unit that controls the light emission unit to illuminate the reading object in response to the progress of the game provided by the game processing unit; and
a first communication unit that transmits the identification information read by the information reading unit to the server,
wherein the server comprises a second communication unit that transmits a history information that indicates a history of usage of the reading object that is identified by the identification information transmitted from the first communication unit of the gaming machine, and
wherein the control unit controls the light emission unit to illuminate the reading object in accordance with the history information transmitted from the second communication unit of the server.

18. The gaming system according to claim 17, wherein the server further comprises an update unit that updates the history information based on the identification information transmitted the first communication unit of the gaming machine, and
wherein the second communication unit transmits the history information being updated by the update unit.
